(19) United States
(12) Patent Application Publication
(10) Pub. No.: US 2020/0233330 A1
(43) Pub. Date: Jul. 23, 2020

(54) LIQUID DEVELOPING AGENT

(71) Applicant: Kao Corporation, Tokyo (JP)

(72) Inventors: Tatsuya YAMADA, Wakayama-shi (JP); Nobumichi KAMIYOSHI, Wakayama-shi (JP); Kosuke TAKEDA, Wakayama-shi (JP)

(73) Assignee: Kao Corporation, Tokyo (JP)

(21) Appl. No.: 16/652,131

(22) PCT Filed: Nov. 28, 2018
(86) PCT No.: PCT/JP2018/043671

§ 371 Date: Mar. 30, 2020

(30) Foreign Application Priority Data
Nov. 29, 2017 (JP) 2017-229385
Nov. 29, 2017 (JP) 2017-229386
Nov. 29, 2017 (JP) 2017-229387

(51) Int. Cl. G03G 9/13; G03G 9/125

(52) U.S. Cl. CPC G03G 9/132; G03G 9/125

(57) ABSTRACT

A liquid developer containing toner particles containing a resin binder and a colorant, a dispersant, and an insulating liquid, wherein the resin binder contains a polyester-based resin, and wherein the insulating liquid contains 50% by mass or more of a saturated fatty acid ester which is an ester of a saturated fatty acid and an alcohol having 3 or more carbon atoms. The liquid developer of the present invention is suitably used in development or the like of latent images formed in, for example, electrophotography, electrostatic recording method, electrostatic printing method or the like.

### FIELD OF THE INVENTION

The present invention relates to a liquid developer usable in development of latent images formed in, for example, electrophotography, electrostatic recording method, electrostatic printing method or the like.

### BACKGROUND OF THE INVENTION

Electrophotographic developers are a dry developer in which toner particles composed of materials containing a colorant and a resin binder are used in a dry state, and a liquid developer in which toner particles are dispersed in an insulating liquid.

In a liquid developer, toner particles are dispersed in oil in an insulating liquid, thereby making it possible to form smaller particle sizes as compared to a dry developer. Therefore, high-quality printouts can be obtained surpassing offset printing, so that the liquid developer is suitable for applications in commercial printings. In addition, in the recent years, since the demands for speeding up have been increasing, liquid developers with reduced viscosities have been desired. Also, a liquid developer in which toner particles are melt-fusable with a smaller amount of heat, in other words, a liquid developer having an excellent low-temperature fusing ability, has been desired.

Patent Publication 1 discloses a developer in which toner particles mainly constituted by resin materials are dispersed in an insulating liquid, characterized in that the insulating liquid contains an unsaturated fatty acid monoester, wherein the unsaturated fatty acid monoester contains an alcohol component having from 1 to 8 carbon atoms, and the content of the unsaturated fatty acid monoester in the insulating liquid is from 10 to 80 wt %, and that the volume resistivity of the insulating liquid is 10¹² Ωcm or more, and that the weight-average molecular weight Mw of the resin materials is from 5,000 to 15,000, for the purposes of providing an environment-friendly liquid developer while having excellent fusing properties of the toner particles to a recording medium, and providing an image-formation apparatus using the liquid developer described above.

Patent Publication 2 discloses a liquid developer which contains an insulating liquid, and toner particles dispersed in the insulating liquid, characterized in that the insulating liquid contains a fatty acid monoester which is an ester of a fatty acid and a monohydric alcohol, and that an aniline point of the insulating liquid is from 5° to 80° C., for the purposes of providing a liquid developer having not only excellent storage property, but also excellent fusing properties of the toner particles to a recording medium, and of providing an image-formation apparatus using a liquid developer described above.

Patent Publication 3 discloses an insulating liquid for a liquid developer characterized in that the insulating liquid contains a lauric acid monoester which is an ester formed between lauric acid and a monohydric alcohol, for the purposes of providing an insulating liquid having not only excellent storage property and long-term stability, but also excellent fusing properties of the toner particles to a recording medium, a liquid developer, and a method for producing a liquid developer, and an image-formation apparatus using a liquid developer described above.

Patent Publication 4 discloses a liquid developer comprising mainly toner particles constituted by resin materials, and a non-volatile insulating liquid, characterized in that the toner particles contain a fatty acid monoester, and that the resin materials contained in the toner particles are swollen by the fatty acid monoester, for the purposes of providing a liquid developer capable of not only being environment-friendly and having excellent low-temperature fusing ability, but also being capable of thinly fusing toner particles to a recording medium, providing a method for producing a liquid developer capable of efficiently producing a liquid developer described above, and providing an image-formation apparatus using a liquid developer described above.
Patent Publication 1: Japanese Patent Laid-Open No. 2008-26571
Patent Publication 2: Japanese Patent Laid-Open No. 2008-203568
Patent Publication 3: Japanese Patent Laid-Open No. 2008-203681
Patent Publication 4: Japanese Patent Laid-Open No. 2008-299141

### SUMMARY OF THE INVENTION

The present invention relates to a liquid developer containing toner particles containing a resin binder and a colorant, a dispersant, and an insulating liquid, wherein the resin binder contains a polyester-based resin, and wherein the insulating liquid contains 50% by mass or more of a saturated fatty acid ester which is an ester of a saturated fatty acid and an alcohol having 3 or more carbon atoms.

### DETAILED DESCRIPTION OF THE INVENTION

However, in the conventional techniques, the lowering in the viscosities of the liquid developers and storage stability are insufficient, which make them difficult to deal with speeding up which are advancing in the recent years. Specifically, the film formation failure may be generated on a roller rotated at a high speed due to high viscosities, or a stress may be applied near the blade within the printer during the speeding up, so that the liquid developer is locally heated to 50° C. or so, which results in undesired generation of toner aggregation.

The present invention relates to a liquid developer having smaller particle sizes, a low viscosity and excellent storage stability and low-temperature fusing ability.

In addition, in a case where a fatty acid ester is used as an insulating liquid in order to improve low-temperature fusing ability, the polarity is higher and the resistance is lower as compared to those of the hydrocarbon-based oils and the silicone oils. Further, since the fatty acid ester has a high affinity with a polyester-based resin, the fatty acid ester is more likely to be present on the toner surface, thereby inhibiting the adsorption of a basic dispersant to the toner, and whereby the basic dispersant is more easily likely to be freed into the insulating liquid. From the above points, the liquid developer in which a fatty acid ester is used is likely to be less resistive, which might invite the worsening of the image quality.

In view of the above, the present invention further relates to a liquid developer having smaller particle sizes, a low viscosity, a high resistance and excellent storage stability and low-temperature fusing ability.

The liquid developer of the present invention exhibits some effects of having smaller particle sizes, a low viscosity and excellent storage stability and low-temperature fusing ability. In addition, in the liquid developer of the present invention, in a case where the dispersant contains a silicone-based basic dispersant, or a case where the liquid developer contains a polyester-based resin having a high acid value and a basic dispersant having a basic nitrogen-containing group, the liquid developer exhibits some effects of further being highly resistive.

The liquid developer of the present invention is a liquid developer containing toner particles containing a resin binder and a colorant, a dispersant, and an insulating liquid, wherein the resin binder contains a polyester-based resin, and wherein the insulating liquid contains 50% by mass or more of a saturated fatty acid ester which is an ester of a saturated fatty acid and an alcohol having 3 or more carbon atoms, the liquid developer having small particle size, a low viscosity and excellent storage stability and low-temperature fusing ability.

Although the reasons why such effects are exhibited are not ascertained, they are assumed to be as follows.

Since a saturated fatty acid ester has an ester bond, its affinity with a polyester-based resin is high, so that the saturated fatty acid ester is penetrated into the resin to plasticize the resin, thereby having excellent low-temperature fusing ability. In addition, in a case where a saturated fatty acid ester is present in the interface of a polyester-based resin and a substrate material (paper or the like), an ester bond in the saturated fatty acid ester interacts with both the polyester-based resin and the substrate material (paper or the like), thereby enhancing the adhesion effects of the resin to the substrate material, whereby having excellent low-temperature fusing ability. On the other hand, when the plasticizing effects of the resin are in excess, the toner particles themselves are fused or aggregated, so that the formation of coarse particles or thickening is likely to be generated.

In view of the above, as a result of intensive studies, the present inventors have found that a molecular structure of a saturated fatty acid and an alcohol constituting the saturated fatty acid ester is important in order to control the degree of plasticization. By using a saturated fatty acid ester, which is an ester made from a saturated fatty acid, preferably a saturated fatty acid having 8 or more carbon atoms and 16 or less carbon atoms, and an alcohol having 3 or more carbon atoms, the molecular chain becomes appropriately bulky, so that excessive penetration into the resin or the plasticization is inhibited, whereby it is assumed that smaller particle sizes, a low viscosity and excellent low-temperature fusing ability and storage stability are obtained.

In view of the above, a first embodiment of a liquid developer of the present invention is a liquid developer defined above in which the number of carbon atoms of the saturated fatty acid in the saturated fatty acid ester is 8 or more and 16 or less.

In addition, in a case where a fatty acid ester is used in an insulating liquid, as mentioned above, since the resistance of the fatty acid ester is low and a basic dispersant is likely to be freed, thereby making it likely to invite the lowering of resistance of the liquid developer. However, as a result of studies, the present inventors have found that the lowering of resistance upon freeing a dispersant can be inhibited by controlling the structure of the dispersant.

In view of the above, a second embodiment of a liquid developer of the present invention is a liquid developer defined above in which the dispersant contains a silicone-based basic dispersant.

In a case where a basic dispersant having a polysiloxane unit having a low polarity and high insulating property is used, the dispersant itself becomes highly resistive, so that it is considered that the resistance is less likely to be lowered even when being freed.

Further, the adhesive strength of the tape and the toner layer is weakened due to the releasing effects of the silicone-based basic dispersant adsorbed on the toner surface, so that the fused image is assumed to be less likely to be removed with the tape even at low-temperature fusing.

Further, the present inventors have found that the freed dispersant is reduced by a combination of a polyester-based resin having a high acid value and a basic dispersant having a basic nitrogen-containing group, to deal with the lowering of resistance of a liquid developer in which a fatty acid ester is used in an insulating liquid.

In view of the above, a third embodiment of a liquid developer of the present invention is a liquid developer defined above containing a polyester-based resin having a high acid value and a basic dispersant having a basic nitrogen-containing group.

It is assumed that the dispersant is likely to be adsorbed to a toner surface by increasing an acid value of a polyester-based resin, in other words, by increasing carboxy groups at a polyester terminal, thereby increasing adsorption points with a basic dispersant, so that the freed dispersant is reduced, and whereby the lowering of resistance can be inhibited.

A liquid developer of a first embodiment, i.e., a liquid developer containing toner particles containing a resin binder and a colorant, a dispersant, and an insulating liquid, wherein the resin binder contains a polyester-based resin, and wherein the insulating liquid contains 50% by mass or more of a saturated fatty acid ester which is an ester of a saturated fatty acid having 8 or more carbon atoms and 16 or less carbon atoms and an alcohol having 3 or more carbon atoms, will be explained.

The resin binder contains a polyester-based resin. The polyester-based resin includes polyester resins, and composite resins having polyester resins and other resins, preferably styrenic resins and the like.

It is preferable that the polyester resin is a polycondensate of an alcohol component containing a dihydric or higher polyhydric alcohol, and a carboxylic acid component containing a dicarboxylic or higher polycarboxylic acid compound.

The dihydric alcohol includes, for example, aliphatic diols, preferably aliphatic diols having 2 or more carbon atoms and 20 or less carbon atoms, and more preferably having 2 or more carbon atoms and 15 or less carbon atoms; an alkylene oxide adduct of bisphenol A represented by the formula (I):

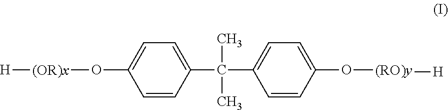

wherein OR and RO are an oxyalkylene group, wherein R is an ethylene group and/or a propylene group; and each of x and y is a positive number showing an average number of moles of alkylene oxide added, wherein a value of the sum of x and y is 1 or more, and preferably 1.5 or more, and 16 or less, preferably 8 or less, more preferably 6 or less, and even more preferably 4 or less,

bisphenol A, hydrogenated bisphenol A, and the like. Specific examples of the aliphatic diol include ethylene glycol, 1,2-propanediol, 1,3-propanediol, 1,4-butanediol, 1,6-hexanediol, and the like. Among them, an aliphatic diol having a hydroxyl group bonded to a secondary carbon atom having 3 or more carbon atoms and 5 or less carbon atoms, and preferably 3 or more carbon atoms and 4 or less carbon atoms is preferred.

The alcohol component is preferably the aliphatic diol or the alkylene oxide adduct of bisphenol A represented by the formula (I), from the viewpoint of improving pulverizability of the toner, thereby obtaining the toner particles having smaller particle sizes, from the viewpoint of improving low-temperature fusing ability of the toner, and from the viewpoint of improving dispersion stability of the toner particles, thereby improving storage stability, and more preferably the aliphatic diol, from the viewpoint of improving pulverizability of the toner, thereby obtaining the toner particles having smaller particle sizes, and from the viewpoint of improving dispersion stability of the toner particles, thereby improving storage stability, and even more preferably an aliphatic diol having a hydroxyl group bonded to a secondary carbon atom having 3 or more carbon atoms and 5 or less carbon atoms. The content of the aliphatic diol or the alkylene oxide adduct of bisphenol A represented by the formula (I) is preferably 50% by mol or more, more preferably 70% by mol or more, even more preferably 90% by mol or more, even more preferably 95% by mol or more, and even more preferably 100% by mol, of the alcohol component. When the aliphatic diol and the alkylene oxide adduct of bisphenol A represented by the formula (I) are used together, it is preferable that a total content of the both is within the above range.

The dicarboxylic acid compound includes, for example, dicarboxylic acids having 3 or more carbon atoms and 30 or less carbon atoms, preferably having 3 or more carbon atoms and 20 or less carbon atoms, and more preferably having 3 or more carbon atoms and 10 or less carbon atoms, or anhydrides thereof, derivatives thereof such as alkyl esters of which alkyl group has 1 or more carbon atoms and 3 or less carbon atoms, and the like. Specific examples of the dicarboxylic acid include aromatic dicarboxylic acids such as phthalic acid, isophthalic acid, and terephthalic acid; and aliphatic dicarboxylic acids such as fumaric acid, maleic acid, succinic acid, glutaric acid, adipic acid, sebacic acid, and succinic acid substituted with an alkyl group having 1 or more carbon atoms and 20 or less carbon atoms or with an alkenyl group having 2 or more carbon atoms and 20 or less carbon atoms.

The carboxylic acid component is preferably terephthalic acid or/and fumaric acid, from the viewpoint of improving low-temperature fusing ability of the toner, and from the viewpoint of improving dispersion stability of the toner particles, thereby improving storage stability. The content of the terephthalic acid or fumaric acid is preferably 40% by mol or more, more preferably 50% by mol or more, and even more preferably 70% by mol or more, of the carboxylic acid component. When terephthalic acid and fumaric acid are used together, it is preferable that a total content of the both is within the above range.

The tricarboxylic or higher polycarboxylic acid compound includes, for example, tricarboxylic or higher polycarboxylic acids having 4 or more carbon atoms and 20 or less carbon atoms, preferably having 6 or more carbon atoms and 20 or less carbon atoms, more preferably having 7 or more carbon atoms and 15 or less carbon atoms, even more preferably having 8 or more carbon atoms and 12 or less carbon atoms, and even more preferably having 9 or more carbon atoms and 10 or less carbon atoms, or anhydrides thereof, derivatives thereof such as alkyl esters of which alkyl group has 1 or more carbon atoms and 3 or less carbon atoms and the like. Specific examples include 1,2,4-benzenetricarboxylic acid (trimellitic acid), 1,2,4,5-benzenetetracarboxylic acid (pyromellitic acid), or acid anhydrides thereof, and the like.

The content of the tricarboxylic or higher polycarboxylic acid compound is preferably 60% by mol or less, more preferably 50% by mol or less, even more preferably 30% by mol or less, even more preferably 25% by mol or less, even more preferably 20% by mol or less, and even more preferably 15% by mol or less, of the carboxylic acid component, from the viewpoint of improving dispersion stability of the toner particles, thereby improving the storage stability.

Here, the alcohol component may contain a monohydric alcohol, and the carboxylic acid component may contain a monocarboxylic acid compound in proper amounts, from the viewpoint of adjusting a molecular weight and a softening point of the polyester resin.

The equivalent ratio of the carboxylic acid component to the alcohol component in the polyester resin, i.e. COOH group or groups/OH group or groups, is preferably 0.6 or more, more preferably 0.7 or more, and even more preferably 0.75 or more, and preferably 1.1 or less, and more preferably 1.05 or less, from the viewpoint of adjusting a softening point of the polyester resin.

The polyester resin can be produced, for example, by polycondensing the alcohol component and the carboxylic acid component in an inert gas atmosphere at a temperature of preferably 130° C. or higher, and more preferably 170° C. or higher, and preferably 250° C. or lower, and more preferably 240° C. or lower, preferably in the presence of an esterification catalyst, further optionally in the presence of an esterification promoter, a polymerization inhibitor or the like.

The esterification catalyst includes tin compounds such as dibutyltin oxide and tin(II) 2-ethylhexanoate; titanium compounds such as titanium diisopropylate bistriethanolaminate; and the like, and the tin compounds are preferred. The amount of the esterification catalyst used is preferably 0.01 parts by mass or more, and more preferably 0.1 parts by mass or more, and preferably 1.5 parts by mass or less, and more preferably 1 part by mass or less, based on 100 parts by mass of a total amount of the alcohol component and the carboxylic acid component. The esterification promoter includes gallic acid, and the like. The amount of the esterification promoter used is preferably 0.001 parts by mass or more, and more preferably 0.01 parts by mass or more, and preferably 0.5 parts by mass or less, and more preferably 0.1 parts by mass or less, based on 100 parts by mass of a total amount of the alcohol component and the carboxylic acid component. The polymerization inhibitor includes t-butyl catechol, and the like. The amount of the polymerization inhibitor used is preferably 0.001 parts by mass or more, and more preferably 0.01 parts by mass or more, and preferably 0.5 parts by mass or less, and more preferably 0.1 parts by mass or less, based on 100 parts by mass of a total amount of the alcohol component and the carboxylic acid component.

Here, in the present invention, the polyester resin may be a modified polyester resin to an extent that the properties thereof are not substantially impaired. The modified polyester resin includes, for example, a polyester resin grafted or blocked with a phenol, a urethane, an epoxy or the like according to a method described in Japanese Patent Laid-Open No. Hei-11-133668, Hei-10-239903, Hei-8-20636, or the like. Among the modified polyester resins, urethane-modified polyester resins in which polyester resins are urethane-extended with a polyisocyanate compound are preferred.

The composite resin having a polyester resin and a styrenic resin includes a resin in which a polyester resin and a styrenic resin are chemically bonded via a dually reactive monomer which is capable of reacting with both the raw material monomers for the polyester resin and the raw material monomers for the styrenic resin, in accordance with a method described in, for example, Japanese Patent Laid-Open No. 2017-062379.

The softening point of the polyester-based resin is preferably 85° C. or higher, and more preferably 90° C. or higher, from the viewpoint of improving dispersion stability of the toner particles, thereby improving storage stability, and the softening point is preferably 130° C. or lower, more preferably 120° C. or lower, and even more preferably 110° C. or lower, from the viewpoint of improving low-temperature fusing ability of the toner.

The glass transition temperature of the polyester-based resin is preferably 45° C. or higher, and more preferably 50° C. or higher, from the viewpoint of improving dispersion stability of the toner particles, thereby improving storage stability, and the glass transition temperature is preferably 80° C. or lower, more preferably 75° C. or lower, and even more preferably 60° C. or lower, from the viewpoint of improving low-temperature fusing ability.

The acid value of the polyester-based resin is preferably 3 mgKOH/g or more, and more preferably 5 mgKOH/g or more, and the acid value is preferably 90 mgKOH/g or less, more preferably 80 mgKOH/g or less, even more preferably 70 mgKOH/g or less, even more preferably 50 mgKOH/g or less, even more preferably 30 mgKOH/g or less, even more preferably 20 mgKOH/g or less, even more preferably 15 mgKOH/g or less, and even more preferably 10 mgKOH/g or less, from the viewpoint of dispersion stability of the toner particles.

The content of the polyester-based resin in the resin binder is preferably 90% by mass or more, more preferably 95% by mass or more, and even more preferably 100% by mass, i.e. only the polyester-based resin is used. However, other resin besides the polyester-based resin may be contained within the range that would not impair the effects of the present invention. The resins besides the polyester-based resin include, for example, one or more members selected from resins such as styrenic resins which are homopolymers or copolymers containing styrene or styrene substitutes, such as polystyrenes, styrene-propylene copolymers, styrene-butadiene copolymers, styrene-vinyl chloride copolymers, styrene-vinyl acetate copolymers, styrene-maleic acid copolymers, styrene-acrylate ester copolymers, and styrene-methacrylate ester copolymers, epoxy-based resins, rosin-modified maleic acid resins, polyethylene-based resins, polypropylene-based resins, polyurethane-based resins, silicone-based resins, phenolic resins, and aliphatic or alicyclic hydrocarbon resins.

As the colorant, dyes, pigments and the like which are used as colorants for toners can be used. Examples include carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazo yellow, and the like. In the present invention, the toner particles may be any one of black toners and color toners.

The content of the colorant is preferably 5 parts by mass or more, more preferably 10 parts by mass or more, and even more preferably 15 parts by mass or more, based on 100 parts by mass of the resin binder, from the viewpoint of improving optical density, and the content is preferably 100 parts by mass or less, more preferably 70 parts by mass or less, even more preferably 50 parts by mass or less, and even more preferably 30 parts by mass or less, based on 100 parts by mass of the resin binder, from the viewpoint of improving pulverizability of the toner, thereby forming smaller particle sizes, from the viewpoint of improving low-temperature fusing ability, and from the viewpoint of improving dispersion stability of the toner particles, thereby improving storage stability.

The toner particles may properly contain, in addition to the resin binder and the colorant, an additive such as a releasing agent, a charge control agent, a charge control resin, a magnetic particulate, a fluidity improver, an electric conductivity modifier, a reinforcing filler such as a fibrous material, an antioxidant, or a cleanability improver.

The method for producing toner particles includes

a method including melt-kneading toner raw materials containing a resin binder and a colorant, and pulverizing, preferably wet-milling, a melt-kneaded product obtained;

a method including mixing an aqueous resin binder dispersion and an aqueous colorant dispersion to unify the resin binder particles and the colorant particles; or

a method including stirring an aqueous resin binder dispersion and a colorant at a high speed, and the like.

The method including melt-kneading toner raw materials and pulverizing, preferably wet-milling a melt-kneaded product obtained is preferred, from the viewpoint of improving developing ability and fusing ability.

First, it is preferable that the toner raw materials containing a resin binder, a colorant, optionally used additives and the like are previously mixed with a mixer such as a Henschel mixer, a Super mixer or a ball-mill, and the mixture is then fed to a kneader, and the Henschel mixer is more preferred, from the viewpoint of improving colorant dispersibility in the resin binder.

The mixing with a Henschel mixer is carried out while adjusting a peripheral speed of agitation, and agitation time. The peripheral speed is preferably 10 m/sec or more and 30 m/sec or less, from the viewpoint of improving colorant dispersibility. In addition, the agitation time is preferably 1 minute or more and 10 minutes or less, from the viewpoint of improving colorant dispersibility.

Next, the melt-kneading of toner raw materials can be carried out with a known kneader, such as a tightly closed kneader, a single-screw or twin-screw kneader, or a continuous open-roller type kneader. In the method for production of the present invention, an open-roller type kneader is preferred, from the viewpoint of improving colorant dispersibility, and from the viewpoint of improving an yield of the toner particles after pulverization.

The open-roller type kneader refers to a kneader of which melt-kneading unit is an open type, not being tightly closed, which can easily dissipate the kneading heat generated during the melt-kneading. The open-roller type kneader used in the present invention is provided with a plurality of feeding ports for raw materials and a discharging port for a kneaded product along the shaft direction of the roller, and it is preferable that the open-roller type kneader is a continuous open-roller type kneader, from the viewpoint of production efficiency.

It is preferable that the open-roller type kneader comprises at least two kneading rollers having different temperatures.

It is preferable that the setting temperatures of the rollers are equal to or lower than a temperature that is 10° C. higher than the softening point of the resin, from the viewpoint of improving miscibility of the toner raw materials.

In addition, it is preferable that the setting temperature of the roller at an upstream side is higher than the setting temperature of the roller at a downstream side, from the viewpoint of making the adhesiveness of the kneaded mixture to the roller at an upstream side favorable and strongly kneading at a downstream side.

It is preferable that the rollers have peripheral speeds that are different from each other. In the open roller-type kneader provided with the above two rollers, it is preferable that the heat roller having a higher temperature is a high-rotation roller, and that the cooling roller having a lower temperature is a low-rotation roller, from the viewpoint of improving fusing ability of the liquid developer.

The peripheral speed of the high-rotation roller is preferably 2 m/min or more, and more preferably 5 m/min or more, and preferably 100 m/min or less, and more preferably 75 m/min or less. The peripheral speed of the low-rotation roller is preferably 2 m/min or more, and more preferably 4 m/min or more, and preferably 100 m/min or less, more preferably 60 m/min or less, and even more preferably 50 m/min or less. Also, the ratio of the peripheral speeds of the two rollers, i.e. low-rotation roller/high-rotation roller, is preferably 1/10 or more, and more preferably 3/10 or more, and preferably 9/10 or less, and more preferably 8/10 or less.

In addition, structures, size, materials and the like of each of the rollers are not particularly limited. The surface of the roller comprises a groove used in kneading, and the shapes of grooves include linear, spiral, wavy, rugged or other forms.

Next, the melt-kneaded product is cooled to an extent that is pulverizable, and the cooled product is subjected to a pulverizing step and optionally a classifying step, whereby the toner particles can be obtained.

The pulverizing step may be carried out in divided multi-stages. For example, the melt-kneaded product may be roughly pulverized to a size of from 1 to 5 mm or so, and the roughly pulverized product may then be further finely pulverized. In addition, in order to improve productivity during the pulverizing step, the melt-kneaded product may be mixed with fine inorganic particles made of hydrophobic silica or the like, and then pulverized.

The pulverizer suitably used in the rough pulverization includes, for example, an atomizer, Rotoplex, and the like, or a hammer-mill or the like may be used. In addition, the pulverizer suitably used in the fine pulverization includes a fluidised bed opposed jet mill, an air jet mill, a mechanical mill, and the like.

The classifier usable in the classifying step includes an air classifier, a rotor type classifier, a sieve classifier, and the like. Here, the pulverizing step and the classifying step may be repeated as occasion demands.

The toner particles obtained, in this step have a volume-median particle size D₅₀ of preferably 3 μm or more, and more preferably 4 μm or more, and preferably 15 μm or less, and more preferably 12 μm or less, from the viewpoint of improving productivity of the wet-milling step described later. Here, the volume-median particle size D₅₀ means a particle size of which cumulative volume frequency calculated on a volume percentage is 50% counted from the smaller particle sizes. Here, it is preferable that the toner particles are mixed with a dispersant and an insulating liquid, and then further finely pulverized by wet-milling or the like.

The content of the toner particles, based on 100 parts by mass of the insulating liquid, is preferably 10 parts by mass or more, more preferably 20 parts by mass or more, even more preferably 30 parts by mass or more, even more preferably 40 parts by mass or more, and even more preferably 50 parts by mass or more, from the viewpoint of high-speed printability, and the content is preferably 100 parts by mass or less, more preferably 80 parts by mass or less, even more preferably 70 parts by mass or less, and even more preferably 60 parts by mass or less, from the viewpoint of improving dispersion stability.

It is preferable that the dispersant in the present invention is a basic dispersant having a basic nitrogen-containing group, from the viewpoint of high adsorbability to the resin having an acidic group. The basic nitrogen-containing group is preferably at least one member selected from the group consisting of amino groups (—NH₂, —NHR, —NHRR′), an amide group (—C(═O)—NRR′), an imide group (—N(COR)₂), a nitro group (—NO₂), an imino group (═NH), a cyano group (—CN), an azo group (—N═N—), a diazo group (═N₂), and an azide group (—N₃). Here, R or R′ is a hydrocarbon group having from 1 to 5 carbon atoms. The amino groups and/or the imino group is preferred, from the viewpoint of adsorbability of the dispersant to the toner particles, and the imino group is more preferred, from the viewpoint of chargeability of the toner particles.

The functional group contained besides the basic nitrogen-containing group includes, for example, a hydroxy group, a formyl group, an acetal group, an oxime group, a thiol group, and the like.

The proportion of the basic nitrogen-containing group occupying the basic dispersant, as calculated in terms of the number of heteroatoms, is preferably 70% by number or more, more preferably 80% by number or more, even more preferably 90% by number or more, even more preferably 95% by number or more, and even more preferably 100% by number, from the viewpoint of dispersion stability.

It is preferable that the basic dispersant contains a group derived from a hydrocarbon having 16 or more carbon atoms, a hydrocarbon having 16 or more carbon atoms partly substituted with a halogen atom, a hydrocarbon having 16 or more carbon atoms having a reactive functional group, a polymer of a hydroxycarboxylic acid having 12 or more carbon atoms, a polymer obtained from a dibasic acid having 2 or more carbon atoms and 22 or less carbon atoms and a diol having 2 or more carbon atoms and 22 or less carbon atoms, a polymer of an alkyl (meth)acrylate having 16 or more carbon atoms, a polyolefin or the like (hereinafter also referred to as “dispersible group”), from the viewpoint of dispersibility of the liquid developer.

The hydrocarbon having 16 or more carbon atoms is preferably a hydrocarbon having 16 or more carbon atoms and 24 or less carbon atoms, which includes, for example, hexadecene, octadecene, eicosane, docosane, and the like.

The hydrocarbon having 16 or more carbon atoms partly substituted with a halogen atom is preferably a hydrocarbon having 16 or more carbon atoms and 24 or less carbon atoms partly substituted with a halogen atom, which includes, for example, chlorohexadecane, bromohexadecane, chlorooctadecane, bromooctadecane, chloroeicosane, bromoeicosane, chlorodocosane, bromodocosane, and the like.

The hydrocarbon having 16 or more carbon atoms having a reactive functional group is preferably a hydrocarbon having 16 or more carbon atoms and 24 or less carbon atoms having a reactive functional group, which includes, for example, hexadecenylsuccinic acid, octadecenylsuccinic acid, eicosenylsuccinic acid, docosenylsuccinic acid, hexadecyl glycidyl ether, octadecyl glycidyl ether, eicosyl glycidyl ether, docosyl glycidyl ether, and the like.

The polymer of a hydroxycarboxylic acid having 12 or more carbon atoms is preferably a polymer of a hydroxycarboxylic acid having 12 or more carbon atoms and 24 or less carbon atoms, and preferably having 16 or more carbon atoms and 24 or less carbon atoms, which includes, for example, a polymer of 12-hydroxystearic acid, and the like.

The polymer obtained from a dibasic acid having 2 or more carbon atoms and 22 or less carbon atoms and a diol having 2 or more carbon atoms and 22 or less carbon atoms includes, for example, a polymer obtained from ethylene glycol and sebacic acid, a polymer obtained from 1,4-butanediol and fumaric acid, a polymer obtained from 1,6-hexanediol and fumaric acid, a polymer obtained from 1,10-decanediol and sebacic acid, a polymer obtained from 1,12-dodecanediol and 1,12-dodecanedioic acid, and the like.

The polymer of an alkyl (meth)acrylate having 16 or more carbon atoms is preferably a polymer of an alkyl (meth)acrylate having 16 or more carbon atoms and 24 or less carbon atoms, which includes, for example, a polymer of hexadecyl methacrylate, a polymer of octadecyl methacrylate, a polymer of docosyl methacrylate, and the like.

The polyolefin includes, for example, polyethylene, polypropylene, polybutylene, polyisobutene, polymethylpentene, polytetradecene, polyhexadecene, polyoctadecene, polyeicosene, polydocosene, and the like.

The basic dispersant preferably has a polyolefin unit, and more preferably having a polypropylene unit and/or a polyisobutene unit, from the viewpoint of dispersibility of the toner particles, and the basic dispersant even more preferably has a polyisobutene unit, from the viewpoint of dissolubility of the dispersant in the insulating liquid. Therefore, among the above dispersible groups, a group derived from a polyolefin is preferred, a group derived from polypropylene and/or a group derived from polyisobutene is more preferred, and a group derived from polyisobutene is even more preferred.

The basic dispersant is not particularly limited, and obtained by, for example, reacting raw materials for a basic nitrogen-containing group and raw materials for a dispersible group.

The raw materials for a basic nitrogen-containing group include polyalkyleneimines such as polyethyleneimines, polyallylamines, polyaminoalkyl methacrylates such as poly(dimethylaminoethyl) methacrylates, and the like.

The number-average molecular weight of the raw materials for a basic nitrogen-containing group is preferably 100 or more, more preferably 500 or more, and even more preferably 1,000 or more, from the viewpoint of adsorbability to the resin having an acidic group, and the number-average molecular weight is preferably 15,000 or less, more preferably 10,000 or less, and even more preferably 5,000 or less, from the viewpoint of dispersibility of the toner particles.

The raw materials for a dispersible group include a halogenated hydrocarbon having 16 or more carbon atoms, a hydrocarbon having 16 or more carbon atoms having a reactive functional group, a polymer of a hydroxycarboxylic acid having 12 or more carbon atoms, a polymer obtained from a dibasic acid having 2 or more carbon atoms and 22 or less carbon atoms and a diol having 2 or more carbon atoms and 22 or less carbon atoms, a polymer of an alkyl (meth)acrylate having 16 or more carbon atoms having a reactive functional group, a polyolefin having a reactive functional group, and the like. Among them, the halogenated hydrocarbon having 16 or more carbon atoms, the hydrocarbon having 16 or more carbon atoms having a reactive functional group, the polymer of an alkyl (meth)acrylate having 16 or more carbon atoms and 24 or less carbon atoms having a reactive functional group, or a polyolefin having a reactive functional group is preferred, from the viewpoint of availability and reactivities of the raw materials. The reactive functional group includes a carboxy group, an epoxy group, a formyl group, an isocyanate group, and the like, among which a carboxy group or an epoxy group is preferred, and a carboxy group is more preferred, from the viewpoint of safety and reactivity. Therefore, it is preferable that the compound having a reactive functional group is a carboxylic acid-based compound. The carboxylic acid-based compound includes fumaric acid, maleic acid, ethanoic acid, propanoic acid, butanoic acid, succinic acid, oxalic acid, malonic acid, tartaric acid, anhydrides thereof, or alkyl esters thereof of which alkyl has 1 or more carbon atoms and 3 or less carbon atoms, and the like. Specific examples of the raw materials for a dispersible group include halogenated alkanes such as chlorooctadecane, epoxy-modified polyoctadecyl methacrylate, polyethylene succinic anhydride, chlorinated polypropylene, polypropylene succinic anhydride, polyisobutene succinic anhydride, and the like.

The content of the compound having a polyolefin unit in the raw materials for a dispersible group is preferably 70% by mass or more, more preferably 80% by mass or more, even more preferably 90% by mass or more, and even more preferably 100% by mass, from the viewpoint of dispersibility of the toner particles.

The number-average molecular weight of the raw materials for a dispersible group is preferably 500 or more, more preferably 700 or more, and even more preferably 900 or more, from the viewpoint of dispersibility of the toner particles, and the number-average molecular weight is preferably 5,000 or less, more preferably 4,000 or less, and even more preferably 3,000 or less, from the viewpoint of adsorbability of the dispersant to the toner particles.

The mass ratio of the basic nitrogen-containing group to the dispersible group in the reaction product, i.e., basic nitrogen-containing group/dispersible group, is preferably 3/97 or more, and more preferably 5/95 or more, from the viewpoint of adsorbability to the toner particles, and the mass ratio is preferably 20/80 or less, and more preferably 15/85 or less, from the viewpoint of dispersion stability of the toner particles. Here, the mass ratio of the basic nitrogen-containing group to the dispersible group in the reaction product can be measured by NMR of the reaction product. Alternatively, in the production of a reaction product in which raw materials for a basic nitrogen-containing group and raw materials for a dispersible group are reacted, the mass ratio of the reacted raw material compounds can be assumed to be the mass ratio of the basic nitrogen-containing group to the dispersible group, i.e., basic nitrogen-containing group/dispersible group, in the dispersant.

Other basic dispersant includes a copolymer C of a monomer A having an amino group, and a monomer B represented by the formula (II):

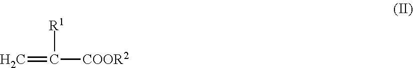

wherein R¹ is a hydrogen atom or an alkyl group having 1 or more carbon atoms and 5 or less carbon atoms, and preferably a methyl group; and R² is an alkyl group having 1 or more carbon atoms and 22 or less carbon atoms or an alkenyl group having 2 or more carbon atoms and 22 or less carbon atoms, each of which may have a substituent, and the like.

It is preferable that the monomer A having an amino group is a monomer having an amino group represented by the formula (III):

CH₂═C(R⁵)COYR⁶NR³R⁴ (III)

wherein each of R³ and R⁴ is independently a hydrogen atom or a linear or branched alkyl group having 1 or more carbon atoms and 4 or less carbon atoms, which may be bonded to each other to form a ring structure; R⁵ is a hydrogen atom or an alkyl having 1 or more carbon atoms and 5 or less carbon atoms, and preferably a methyl group; R⁶ is a linear or branched alkylene group having 2 or more carbon atoms and 4 or less carbon atoms; and Y is —O— or —NH—, or
an acid neutralized product (tertiary amine salt) or a quaternary ammonium salt of this monomer. Preferred acids for obtaining the above acid neutralized product include hydrochloric acid, sulfuric acid, nitric acid, acetic acid, formic acid, maleic acid, fumaric acid, citric acid, tartaric acid, adipic acid, sulfamic acid, toluenesulfonic acid, lactic acid, pyrrolidone-2-carboxylic acid, succinic acid, and the like. The preferred quaternary forming agents for obtaining the above quaternary ammonium salt include alkyl halides such as methyl chloride, ethyl chloride, methyl bromide, and methyl iodide; and general alkylation agents such as dimethyl sulfate, diethyl sulfate, and di-n-propyl sulfate.

In the formula (III), each of R³ and R⁴ independently is preferably a linear or branched alkyl group having 1 or more carbon atoms and 4 or less carbon atoms, and NR³R⁴ is preferably a tertiary amino group. Specific examples of R³ and R⁴ include a methyl group, an ethyl group, a propyl group, an isopropyl group, and the like, and a methyl group is preferred.

R⁶ includes an ethylene group, a propylene group, a butylene group, and the like, and an ethylene group is preferred.

In the formula (III), specific examples of the monomer in which NR³R⁴ is a tertiary amino group (tertiary amino group-containing monomer) include (meth)acrylic esters having a dialkylamino group, (meth)acrylamide having a dialkylamino group, and the like. Here, the term “(meth)acrylic ester” means to embrace both cases of acrylic ester and methacrylic ester, and the term “(meth)acrylamide” means to embrace both cases of acrylamide and methacrylamide.

The (meth)acrylic ester having a dialkylamino group includes one or more members selected from the group consisting of dimethylaminoethyl (meth)acrylate, diethylaminoethyl (meth)acrylate, dipropylaminoethyl (meth)acrylate, diisopropylaminoethyl (meth)acrylate, dibutylaminoethyl (meth)acrylate, diisobutylaminoethyl (meth)acrylate, and di-t-butylaminoethyl (meth)acrylate, and the like.

The (meth)acrylamide having a dialkylamino group includes one or more members selected from the group consisting of dimethylaminopropyl (meth)acrylamide, diethylaminopropyl (meth)acrylamide, dipropylaminopropyl (meth)acrylamide, diisopropylaminopropyl (meth)acrylamide, dibutylaminopropyl (meth)acrylamide, diisobutylaminopropyl (meth)acrylamide, and di-t-butylaminopropyl (meth)acrylamide, and the like.

Among them, the (meth)acrylic ester having a dialkylamino group is preferred, from the viewpoint of smaller particle sizes, lowered viscosity, storage stability, and low-temperature fusing ability, and dimethylaminoethyl (meth)acrylate is more preferred.

The monomer B is represented by the above formula (II), and in the above formula (II), the number of carbon atoms of the alkyl group and the alkenyl group represented by R² is preferably 10 or more, and more preferably 12 or more, from the viewpoint of lowered viscosity, storage stability, and low-temperature fusing ability, and the number of carbon atoms is 22 or less, and the number of carbon atoms is preferably 20 or less, from the viewpoint of adsorbability to the toner particles. The alkyl group or alkenyl group of R² may be linear or branched, which may have a substituent such as a hydroxyl group.

Therefore, it is preferable that the monomer B at least contains a monomer B2 in which R² is an alkyl group or alkenyl group having 10 or more carbon atoms and 22 or less carbon atoms.

In the monomer B, a molar ratio of a monomer B1 in which R² is an alkyl group having 1 or more carbon atoms and 9 or less carbon atoms or an alkenyl group having 2 or more carbon atoms and 9 or less carbon atoms to a monomer B2 in which R² is an alkyl group or alkenyl group having 10 or more carbon atoms and 22 or less carbon atoms, i.e. monomer B1/monomer B2, is 0.1 or less, preferably 0.07 or less, more preferably 0.05 or less, even more preferably 0.03 or less, and even more preferably 0.01 or less, and 0 or more, and preferably 0, from the viewpoint of lowered viscosity, storage stability, and low-temperature fusing ability.

Specific examples of the monomer B include methyl (meth)acrylate, ethyl (meth)acrylate, (iso)propyl (meth)acrylate, 2-hydroxyethyl (meth)acrylate, (iso or tertiary)butyl (meth)acrylate, 2-ethylhexyl (meth)acrylate, (iso)octyl (meth)acrylate, (iso)nonyl (meth)acrylate, (iso)decyl (meth)acrylate, (iso)undecyl (meth)acrylate, (iso)dodecyl (meth)acrylate, (iso)tridecyl (meth)acrylate, (iso)tetradecyl (meth)acrylate, (iso)pentadecyl (meth)acrylate, (iso)hexadecyl (meth)acrylate, (iso)heptadecyl (meth)acrylate, (iso)octadecyl (meth)acrylate, (iso)nonadecyl (meth)acrylate, (iso)icosyl (meth)acrylate, (iso)eicosyl (meth)acrylate, (iso)henicosyl (meth)acrylate, (iso)docosyl (meth)acrylate, and the like. These monomers can be used alone or in two or more kinds. Here, the expression “(iso or tertiary)” or “(iso)” means to embrace both cases where these groups are present and cases where they are absent, and in the cases where these groups are absent, they are normal form. Also, the expression “(meth)acrylate” means to embrace both acrylate and methacrylate.

The molar ratio of the monomer A to the monomer B, i.e., monomer A/monomer B, is preferably 2/98 or more, more preferably 3/97 or more, even more preferably 5/95 or more, and even more preferably 7/93 or more, from the viewpoint of the function as a dispersant, lowered viscosity and storage stability, and the molar ratio is preferably 50/50 or less, more preferably 40/60 or less, even more preferably 35/65 or less, even more preferably 25/75 or less, and even more preferably 20/80 or less, from the viewpoint of lowered viscosity, storage stability, and low-temperature fusing ability.

A total content of the monomer A and the monomer B is preferably 80% by mass or more, more preferably 90% by mass or more, and even more preferably 95% by mass or more, and preferably 100% by mass or less, and more preferably 100% by mass, of the entire monomers usable in the copolymer C.

The polymerization of a monomer A and a monomer B can be carried out, for example, by heating the monomers in a solvent to a temperature of 40° to 140° C. or so in the presence of a polymerization initiator such as 2,2′-azobis(2,4-dimethylvaleronitrile) to react.

The weight-average molecular weight of the basic dispersant is preferably 5,000 or more, more preferably 10,000 or more, and even more preferably 15,000 or more, from the viewpoint of lowered viscosity and low-temperature fusing ability, and the weight-average molecular weight is preferably 100,000 or less, more preferably 95,000 or less, and even more preferably 90,000 or less, from the same viewpoint.

In addition, the number-average molecular weight of the basic dispersant is preferably 2,000 or more, more preferably 2,500 or more, even more preferably 3,000 or more, and even more preferably 3,500 or more, from the viewpoint of lowered viscosity and low-temperature fusing ability, and the number-average molecular weight is preferably 10,000 or less, more preferably 9,000 or less, and even more preferably 8,000 or less, from the same viewpoint.

The content of the basic dispersant, based on 100 parts by mass of the toner particles, is preferably 0.5 parts by mass or more, more preferably 1 part by mass or more, and even more preferably 2 parts by mass or more, from the viewpoint of dispersion stability of the toner particles, and the content is preferably 10 parts by mass or less, more preferably 8 parts by mass or less, and even more preferably 5 parts by mass or less, from the viewpoint of chargeability of the toner.

The liquid developer of the present invention may contain a known dispersant other than the basic dispersant mentioned above. The content of the above basic dispersant in the dispersant is preferably 50% by mass or more, more preferably 70% by mass or more, even more preferably 90% by mass or more, and even more preferably 95% by mass or more, and preferably 100% by mass or less, more preferably substantially 100% by mass, and even more preferably 100% by mass.

The insulating liquid in the present invention means a liquid through which electricity is less likely to flow, and in the present invention, the conductivity of the insulating liquid is preferably 1.0×10⁻¹⁰ S/m or less, and more preferably 5.0×10⁻¹¹ S/m or less, and preferably 1.0×10⁻¹³ S/m or more.

The insulating liquid in the present invention contains a saturated fatty acid ester which is an ester obtained from a saturated fatty acid, preferably a saturated fatty acid having 8 or more carbon atoms and 16 or less carbon atoms, and an alcohol having 3 or more carbon atoms, from the viewpoint of improving dispersion stability of the toner particles, thereby improving storage stability, and from the viewpoint of low-temperature fusing ability and from the viewpoint of making the liquid developer highly resistive.

The saturated fatty acid having 8 or more carbon atoms and 16 or less carbon atoms includes caprylic acid, capric acid, lauric acid, palmitic acid, myristic acid, 2-ethylhexanoic acid, and the like.

The number of carbon atoms of the saturated fatty acid is preferably 8 or more, more preferably 10 or more, and even more preferably 12 or more, from the viewpoint of improving dispersion stability of the toner particles, thereby improving storage stability, and the number of carbon atoms is preferably 16 or less, and more preferably 14 or less, from the viewpoint of improving wet-milling property of the toner, thereby obtaining toner particles having smaller particle sizes, from the viewpoint of improving dispersion stability of the toner particles, thereby improving storage stability, and from the viewpoint of low-temperature fusing ability.

The alcohol having 3 or more carbon atoms includes propanol, isopropanol, hexanol, butanol, isobutanol, octanol, 2-ethylhexyl alcohol, decyl alcohol, isodecyl alcohol, lauryl alcohol, myristyl alcohol, cetyl alcohol, and the like.

The number of carbon atoms of the alcohol is 3 or more, preferably 4 or more, and more preferably 5 or more, from the viewpoint of improving dispersion stability of the toner particles, thereby improving storage stability, and the number of carbon atoms is preferably 16 or less, more preferably 12 or less, and even more preferably 10 or less, from the viewpoint of improving wet-milling property of the toner, thereby obtaining toner particles having smaller particle sizes, from the viewpoint of improving dispersion stability of the toner particles, thereby improving storage stability, and from the viewpoint of low-temperature fusing ability.

The boiling point of the above saturated fatty acid ester is preferably 180° C. or higher, more preferably 220° C. or higher, and even more preferably 240° C. or higher, from the viewpoint of improving dispersion stability of the toner particles, thereby improving storage stability, and from the viewpoint of developing property, and the boiling point is preferably 360° C. or lower, more preferably 350° C. or lower, and even more preferably 340° C. or lower, from the viewpoint of low-temperature fusing ability, and from the viewpoint of improving wet-milling property of the toner, thereby obtaining toner particles having smaller particles.

The viscosity at 25° C. of the above saturated fatty acid ester is preferably 1 mPa·s or more, more preferably 2 mPa·s or more, and even more preferably 3 mPa·s or more, from the viewpoint of improving dispersion stability of the toner particles, thereby improving storage stability, and the viscosity is preferably 15 mPa·s or less, more preferably 10 mPa·s or less, and even more preferably 6 mPa·s or less, from the viewpoint of low-temperature fusing ability, and from the viewpoint of improving wet-milling property of the toner, thereby obtaining toner particles having smaller particles.

The content of the above saturated fatty acid ester is 50% by mass or more, preferably 80% by mass or more, more preferably 90% by more, even more preferably 95% by mass or more, and even more preferably 100% by mass, of the insulating liquid, from the viewpoint of environmental safety and low-temperature fusing ability.

The insulating liquid other than the above saturated fatty acid ester includes, for example, aliphatic hydrocarbons, alicyclic hydrocarbons, aromatic hydrocarbons, halogenated hydrocarbons, polysiloxanes, vegetable oils, and the like.

The liquid developer is obtained by dispersing toner particles in an insulating liquid. It is preferable that toner particles are dispersed in an insulating liquid, and the dispersion is then subjected to wet-milling to provide a liquid developer, from the viewpoint making particle sizes of the toner particles smaller.

It is preferable that a method for mixing toner particles, a dispersant, and an insulating liquid is a method including stirring the components with an agitation mixer, or the like.

The agitation mixer is, but not particularly limited to, preferably high-speed agitation mixers, from the viewpoint of improving productivity and storage stability of the dispersion of toner particles. Specific examples are preferably DESPA manufactured by ASADA IRON WORKS CO., LTD.; T.K. HOMOGENIZING MIXER, T.K. HOMOGENIZING DISPER, T.K. ROBOMIX, hereinabove manufactured by PRIMIX Corporation; CLEARMIX manufactured by M Technique Co., Ltd.; KADY Mill manufactured by KADY International, and the like.

The toner particles are previously dispersed by mixing components with a high-speed agitation mixer, whereby a dispersion of toner particles can be obtained, which in turn improves productivity of a liquid developer by the subsequent wet-milling.

The solid content concentration of the dispersion of toner particles is preferably 20% by mass or more, more preferably 30% by mass or more, and even more preferably 33% by mass or more, from the viewpoint of improving optical density, and the solid content concentration is preferably 50% by mass or less, more preferably 45% by mass or less, and even more preferably 40% by mass or less, from the viewpoint of improving dispersion stability of the toner particles, thereby improving storage stability.

The wet-milling refers to a method of subjecting toner particles dispersed in an insulating liquid to a method of mechanical milling treatment in a dispersed state in the insulating liquid.

As the apparatus used, for example, generally used agitation mixers such as anchor blades can be used. Among the agitation mixers, the apparatuses include high-speed agitation mixers such as DESPA manufactured by ASADA IRON WORKS CO., LTD., and T.K. HOMOGENIZING MIXER manufactured by PRIMIX Corporation; pulverizers or kneaders, such as roller mills, beads-mills, kneaders, and extruders; and the like. These apparatuses can be used in a combination of plural apparatuses.

Among these apparatuses, use of beads-mill is preferred, from the viewpoint of making particle sizes of toner particles smaller, from the viewpoint of improving dispersion stability of the toner particles, thereby improving storage stability, and from the viewpoint of lowering the viscosity of a dispersion thereof.

By controlling particle sizes and filling ratios of media used, peripheral speeds of rotors, residence time, or the like in the beads-mill, toner particles having a desired particle size and a particle size distribution can be obtained.

The solid content concentration of the liquid developer is preferably 10% by mass or more, more preferably 15% by mass or more, and even more preferably 20% by mass or more, from the viewpoint of improving optical density, and the solid content concentration is preferably 50% by mass or less, more preferably 45% by mass or less, and even more preferably 40% by mass or less, from the viewpoint of improving dispersion stability of the toner particles, thereby improving storage stability.

The content of the toner particles in the liquid developer is preferably 10% by mass or more, more preferably 15% by mass or more, and even more preferably 20% by mass or more, from the viewpoint of high-speed printing, and the content is preferably 50% by mass or less, more preferably 45% by mass or less, and even more preferably 40% by mass or less, from the viewpoint of dispersion stability of the toner particles.

The volume-median particle size D₅₀ of the toner particles in the liquid developer is preferably 0.5 μm or more, more preferably 1 μm or more, and even more preferably 1.5 μm or more, from the viewpoint of lowering the viscosity of the liquid developer, and the volume-median particle size is preferably 5 μm or less, more preferably 3 μm or less, and even more preferably 2.5 μm or less, from the viewpoint of improving image quality of the liquid developer.

The glass transition temperature of the toner particles in the liquid developer is preferably 15° C. or higher, and more preferably 20° C. or higher, from the viewpoint of improving dispersion stability of the toner particles, thereby improving storage stability, and the glass transition temperature is preferably 50° C. or lower, more preferably 40° C. or lower, and even more preferably 30° C. or lower, from the viewpoint of low-temperature fusing ability.

The content of the insulating liquid in the liquid developer is preferably 50% by mass or more, more preferably 55% by mass or more, and even more preferably 60% by mass or more, from the viewpoint of dispersion stability of the toner particles, and the content is preferably 90% by mass or less, more preferably 85% by mass or less, and even more preferably 80% by mass or less, from the viewpoint of high-speed printing.

The viscosity at 25° C. of the liquid developer, a solid content concentration of which is 25% by mass is preferably 3 mPa·s or more, more preferably 5 mPa·s or more, even more preferably 6 mPa·s or more, and even more preferably 7 mPa·s or more, from the viewpoint of improving dispersion stability of the toner particles, thereby improving storage stability, and the viscosity is preferably 50 mPa·s or less, more preferably 40 mPa·s or less, even more preferably 30 mPa·s or less, even more preferably 25 mPa·s or less, and even more preferably 20 mPa·s or less, from the viewpoint of improving fusing ability of the liquid developer.

The conductivity of the liquid developer is preferably 5.0×10⁻⁸ S/m or less, more preferably 3.0×10⁻⁸ S/m or less, and even more preferably 1.0×10⁻⁸ S/m or less, from the viewpoint of developing property and image quality of the liquid toner.

A liquid developer of a second embodiment is:

a liquid developer containing toner particles containing a resin binder and a colorant, a dispersant, and an insulating liquid, wherein the dispersant contains a silicone-based basic dispersant, and wherein the resin binder contains a polyester-based resin, and wherein the insulating liquid contains 50% by mass or more of a saturated fatty acid ester which is an ester of a saturated fatty acid and an alcohol having 3 or more carbon atoms. Therefore, it is the same as the liquid developer of the first embodiment except that the number of carbon atoms of the saturated fatty acid in the saturated fatty acid ester is not limited, and is preferably 8 or more and 16 or less, and that the dispersant contains a silicone-based basic dispersant defined below.

Preferred silicone-based basic dispersants in the present invention include, for example, a copolymer C in which monomers containing a monomer having a basic functional group and a monomer having a polysiloxane chain are polymerized.

The basic functional group includes an amino group, an amide group, an imide group, an ammonium salt, and the like, among which an amino group is preferred, and a tertiary amino group is more preferred.

It is preferable that the monomer having a basic functional group is a monomer having an amino group represented by the formula (IV):

CH₂═C(R³)COYR⁴NR¹R² (IV)

wherein each of R¹ and R² is independently a hydrogen atom, or a linear or branched alkyl group having 1 or more carbon atoms and 4 or less carbon atoms, which may be bonded to each other to form a ring structure; R³ is a hydrogen atom or a methyl group; R⁴ is a linear or branched alkylene group having 2 or more carbon atoms and 4 or less carbon atoms; and Y is —O— or —NH—, or
an acid neutralized product or a quaternary ammonium salt of this monomer. Preferred acids for obtaining the above acid neutralized product include hydrochloric acid, sulfuric acid, nitric acid, acetic acid, formic acid, maleic acid, fumaric acid, citric acid, tartaric acid, adipic acid, sulfamic acid, toluenesulfonic acid, lactic acid, pyrrolidone-2-carboxylic acid, succinic acid, and the like. The preferred quaternary forming agents for obtaining the above quaternary ammonium salt include alkyl halides such as methyl chloride, ethyl chloride, methyl bromide, and methyl iodide; and general alkylation agents such as dimethyl sulfate, diethyl sulfate, and di-n-propyl sulfate.

In the formula (IV), each of R¹ and R² independently is preferably a linear or branched alkyl group having 1 or more carbon atoms and 4 or less carbon atoms. Specific examples of R¹ and R² include a methyl group, an ethyl group, a propyl group, an isopropyl group, and the like, and a methyl group is preferred.

R⁴ includes an ethylene group, a propylene group, a butylene group, and the like, and an ethylene group is preferred.

In the formula (IV), specific examples of the monomer in which R¹ and R² are alkyl groups (a monomer having a tertiary amino group) include (meth)acrylic esters having a dialkylamino group, (meth)acrylamide having a dialkylamino group, and the like. Here, the term “(meth)acrylic ester” refers to acrylic ester, methacrylic ester, or both, and the term “(meth)acrylamide” refers to acrylamide, methacrylamide, or both.

The (meth)acrylic ester having a dialkylamino group includes one or more members selected from the group consisting of dimethylaminoethyl (meth)acrylate, diethylaminoethyl (meth)acrylate, dipropylaminoethyl (meth)acrylate, diisopropylaminoethyl (meth)acrylate, dibutylaminoethyl (meth)acrylate, diisobutylaminoethyl (meth)acrylate, and di-t-butylaminoethyl (meth)acrylate, and the like.

The (meth)acrylamide having a dialkylamino group includes one or more members selected from the group consisting of dimethylaminopropyl (meth)acrylamide, diethylaminopropyl (meth)acrylamide, dipropylaminopropyl (meth)acrylamide, diisopropylaminopropyl (meth)acrylamide, dibutylaminopropyl (meth)acrylamide, diisobutylaminopropyl (meth)acrylamide, and di-t-butylaminopropyl (meth)acrylamide, and the like.

It is preferable that the monomer having a polysiloxane chain is a silicone-based macro-monomer represented by the formula (V):

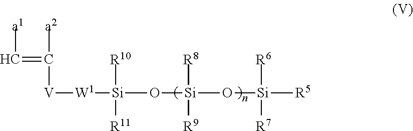

wherein each of a¹ and a², which may be identical or different from each other, is a hydrogen atom, a halogen atom, a cyano group, a hydrocarbon group having 1 or more carbon atoms and 4 or less carbon atoms, —COO—Z¹ or —COO—Z¹ bonded via a divalent hydrocarbon group having 1 or more and 4 or less carbon atoms, wherein Z¹ is a hydrogen atom or a hydrocarbon group which may be substituted; a¹ and a² are preferably a hydrogen atom or a methyl group;

Each of R⁵ to R¹¹ is independently an alkyl group having 1 or more carbon atoms and 10 or less carbon atoms, a phenyl group, an aralkyl group having 7 or more carbon atoms and 16 or less carbon atoms, or an alkoxy group having 1 or more carbon atoms and 10 or less carbon atoms; R⁵ to R¹¹ are preferably an alkyl group having 1 or more carbon atoms and 3 or less carbon atoms, or an alkoxy group having 1 or more carbon atoms and 3 or less carbon atoms, and more preferably a methyl group;

V is —COO—, —COO(CH₂)ₘ—, —OCO—, —OCO(CH₂)ₘ—, —(CH₂)ₖ—OCO—, —(CH₂)ₖ—COO—, —O—, —CONHCOO—, —CONHCO—, —CONH(CH₂)ₘ—, —SO₂—, —CO—, —CONZ²—, —SO₂NZ²— or a phenylene group, wherein Z² is a hydrogen atom or a hydrocarbon group having 1 or more carbon atoms and 4 or less carbon atoms, m is an integer of 1 or more and 10 or less, and k is an integer of 1 or more and 3 or less; V is preferably —COO— or —COO(CH₂)ₘ—;

W¹ is a single linking group or a linking group constituted by any combinations selected from a single bond, or atoms such as —C(Z³)(Z⁴)—, —(CH═CH)—, a cyclohexylene group, a phenylene group, —O—, —S—, —C(═O)—, —N(Z⁵)—, —COO—, —SO₂—, —CON(Z⁵)—, —SO₂N(Z⁵)—, —NHCOO—, —NHCONH— or —Si(Z⁵)(Z⁶)—, wherein each of Z³ and Z⁴ is a hydrogen atom, a halogen atom (for example, a fluorine atom, a chlorine atom, a bromine atom, or the like), a cyano group, or a hydroxy group, and Z⁵ and Z⁶ are the same as Z² defined above, and W¹ is preferably —C(Z³)(Z⁴)— or —O—;

n is an integer of 5 or more, preferably 10 or more, more preferably 30 or more, and even more preferably 40 or more, and 130 or less, preferably 100 or less, and more preferably 80 or less.

A preferred silicone-based macro-monomer represented by the formula (V) includes preferably a silicone-based macro-monomer represented by the formula (Va):

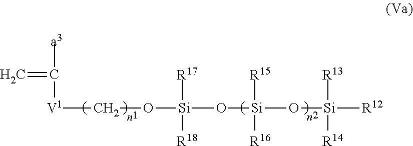

wherein a³ is a hydrogen atom or a methyl group; each of R¹² to R¹⁸ is independently an alkyl group having 1 or more carbon atoms and 10 or less carbon atoms, an alkoxy group having 1 or more carbon atoms and 10 or less carbon atoms, a phenyl group, or —(CH₂)ᵣ—C₆H₅, wherein r is an integer of 1 or more and 10 or less, preferably an alkyl group having 1 or more carbon atoms and 3 or less carbon atoms, and more preferably a methyl group; V¹ is —COO— or —CONH—; n¹ is preferably an integer of 1 or more and 10 or less; and n² is an integer of 5 or more, preferably 10 or more, more preferably 30 or more, and even more preferably 40 or more, and 130 or less, preferably 100 or less, and more preferably 80 or less.

The silicone-based macro-monomer represented by the formula (V) can be produced by conventionally known methods of synthesis. The methods include, for example,

(1) a method according to ion polymerization method, including treating a terminal of a living polymer obtained by anion polymerization or cation polymerization with various reagents to provide a macromer;
(2) a method according to a radical polymerization method, including treating an oligomer bound to a terminal reactive group obtained by a radical polymerization using a polymerization initiator and/or a chain transfer agent, each containing a reactive group in the molecule, such as a carboxy group, a hydroxy group, and/or an amino group, with various reagents to provide a macromer;
(3) a method according to a poly-addition condensation method, including introducing a polymerizable double-bond group to an oligomer obtained by addition polymerization or polycondensation reaction, in the same manner as in the radical polymerization method; and the like.

Commercially available products of the silicone-based macro-monomer include X-24-8201, X-22-174ASX, X-22-174BX, X-22-174DX, KF-2012, hereinabove, manufactured by Shin-Etsu Chemical Co., Ltd.; FM-0711, FM-0721, FM-0725, hereinabove, manufactured by CHISSO CORPORATION; AK-5, AK-30, AK-32, hereinabove, manufactured by TOAGOSEI CO., LTD., and the like.

The weight-average molecular weight of the monomer having a polysiloxane chain is preferably 1,000 or more, more preferably 1,500 or more, even more preferably 2,000 or more, even more preferably 3,000 or more, and even more preferably 4,000 or more, from the viewpoint of lowered viscosity, pulverizability, low-temperature fusing ability, and rubbing resistance, and the weight-average molecular weight is preferably 10,000 or less, more preferably 8,000 or less, and even more preferably 6,000 or less, from the same viewpoint.

The mass ratio of the monomer having a basic functional group to the monomer having a polysiloxane chain, i.e. monomer having a basic functional group/monomer having a polysiloxane chain, is preferably 3/97 or more, more preferably 5/95 or more, and even more preferably 10/90 or more, from the viewpoint of lowered viscosity and pulverizability, and the mass ratio is preferably 70/30 or less, more preferably 50/50 or less, even more preferably 40/60 or less, and even more preferably 30/70 or less, from the viewpoint of lowered viscosity, pulverizability, and rubbing resistance.

A total content of the monomer having a basic functional group and the monomer having a polysiloxane chain is preferably 80% by mass or more, more preferably 90% by mass or more, even more preferably 95% by mass or more, and even more preferably 100% by mass, of the entire monomers usable in the copolymer.

The polymerization of the monomer having a basic functional group and the monomer having a polysiloxane chain can be carried out, for example, by radical polymerization using a polymerization initiator and/or a chain transfer agent.

The weight-average molecular weight of the copolymer C is preferably 80,000 or less, more preferably 70,000 or less, and even more preferably 60,000 or less, from the viewpoint of lowered viscosity, pulverizability, and low-temperature fusing ability, and the weight-average molecular weight is preferably 10,000 or more, more preferably 20,000 or more, and even more preferably 30,000 or more, from the viewpoint of lowered viscosity, pulverizability, and low-temperature fusing ability.

The number-average molecular weight of the copolymer C is preferably 10,000 or less, more preferably 8,000 or less, and even more preferably 7,000 or less, from the viewpoint of lowered viscosity, pulverizability, and low-temperature fusing ability, and the number-average molecular weight is preferably 3,000 or more, more preferably 4,000 or more, and even more preferably 5,000 or more, from the viewpoint of lowered viscosity, pulverizability, and low-temperature fusing ability.

The content of the copolymer C, based on 100 parts by mass of the toner particles, is preferably 0.5 parts by mass or more, more preferably 1 part by mass or more, and even more preferably 2 parts by mass or more, from the viewpoint of dispersion stability of the toner particles, and the content is preferably 10 parts by mass or less, more preferably 8 parts by mass or less, and even more preferably 6 parts by mass or less, from the viewpoint of chargeability and fusing ability.

In addition, another preferred silicone-based basic dispersant includes a reaction product X of raw materials for a basic nitrogen-containing group having a nitrogen-containing group represented by the formula (VI):

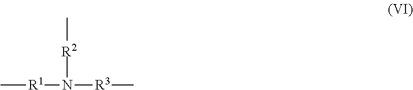

wherein each of R¹, R² and R³, which may be identical or different, is an alkylene group having 1 or more carbon atoms and 22 or less carbon atoms, preferably 1 or more carbon atoms and 10 or less carbon atoms, and more preferably 1 or more carbon atoms and 5 or less carbon atoms, and raw materials for a dispersible group having a polysiloxane chain.

In the formula (VI), the alkylene group having 1 or more carbon atoms and 22 or less carbon atoms includes a methylene group, an ethylene group, a propylene group, and the like.

Here, the reaction product X may have a group in which one or two out of R¹ to R³ is a hydrogen atom, not a divalent group at a terminal or a central part of a group derived from the raw materials for a basic nitrogen-containing group, within the range that would not impair the effects of the present invention.

The number-average molecular weight of the raw materials for a basic nitrogen-containing group is preferably 250 or more, more preferably 500 or more, and even more preferably 1,000 or more, from the viewpoint of adsorbability to the toner particles, and the number-average molecular weight is preferably 5,000 or less, more preferably 4,000 or less, and even more preferably 3,000 or less, from the viewpoint of dispersibility of the toner particles.

The polysiloxane chain in the raw materials for a dispersible group may be linear or cyclic, which may be modified with a halogen atom, an epoxy group, a glycidyl group or the like. It is preferable that the raw materials for a dispersible group having a polysiloxane chain is a compound represented by the formula (VII):

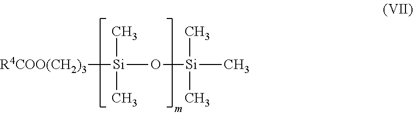

wherein R⁴ is a reactive functional group; and m is the average number of moles added, wherein m is 10 or more and 70 or less, preferably 15 or more and 60 or less, and more preferably 20 or more and 50 or less.

In the formula (VII), the reactive functional group includes a glycidyl group, an epoxy group, a halogen group, and the like, among which a glycidyl group is preferred, from the viewpoint of safety and reactivity. Therefore, it is preferable that the raw materials for a dispersible group having a polysiloxane chain are an epoxy-based compound.

The number-average molecular weight of the raw materials for a dispersible group is preferably 1,000 or more, and more preferably 1,500 or more, from the viewpoint of dispersibility, and the number-average molecular weight is preferably 5,000 or less, more preferably 4,000 or less, and even more preferably 3,000 or less, from the viewpoint of adsorbability to the toner particles.

The mass ratio of the basic nitrogen-containing group to the dispersible group in the reaction product X, i.e., basic nitrogen-containing group/dispersible group, is preferably 1/99 or more, more preferably 2/98 or more, and even more preferably 3/97 or more, from the viewpoint of adsorbability to the toner particles, and the mass ratio is preferably 10/90 or less, more preferably 8/92 or less, and even more preferably 5/95 or less, from the viewpoint of dispersion stability of the toner particles. Here, the mass ratio of the basic nitrogen-containing group to the dispersible group in the reaction product X can be measured by NMR of the reaction product X. Alternatively, in the production of a reaction product X obtained by reacting raw materials for a basic nitrogen-containing group and raw materials for a dispersible group, the mass ratio of the reacted raw material compounds can be regarded as the mass ratio of the basic nitrogen-containing group to the dispersible group in the dispersant, i.e. basic nitrogen-containing group/dispersible group.

The raw materials for a basic nitrogen-containing group and the raw materials for a dispersible group can be reacted by a conventional method.

The weight-average molecular weight of the reaction product X is preferably 50,000 or less, more preferably 40,000 or less, and even more preferably 30,000 or less, from the viewpoint of lowered viscosity, pulverizability, and low-temperature fusing ability, and the weight-average molecular weight is preferably 5,000 or more, more preferably 8,000 or more, and even more preferably 10,000 or more, from the viewpoint of lowered viscosity, pulverizability, and low-temperature fusing ability.

The number-average molecular weight of the reaction product X is preferably 20,000 or less, more preferably 18,000 or less, and even more preferably 15,000 or less, from the viewpoint of lowered viscosity, pulverizability, and low-temperature fusing ability, and the weight-average molecular weight is preferably 3,000 or more, more preferably 5,000 or more, and even more preferably 7,000 or more, from the viewpoint of lowered viscosity, pulverizability, and low-temperature fusing ability.

The content of the reaction product X, based on 100 parts by mass of the toner particles, is preferably 0.1 parts by mass or more, more preferably 0.3 parts by mass or more, and even more preferably 0.5 parts by mass or more, from the viewpoint of dispersion stability of the toner particles, and the content is preferably 8 parts by mass or less, more preferably 6 parts by mass or less, and even more preferably 5 parts by mass or less, from the viewpoint of chargeability and fusing ability.

The liquid developer of the present invention may contain a known dispersant other than the silicone-based basic dispersant, and the content of the silicone-based basic dispersant is preferably 50% by mass or more, more preferably 70% by mass or more, even more preferably 90% by mass or more, even more preferably 95% by mass or more, and even more preferably 100% by mass, of the dispersant.

A liquid developer of a third embodiment is:

a liquid developer containing toner particles containing a resin binder and a colorant, a dispersant, and an insulating liquid, wherein the resin binder contains a polyester-based resin having an acid value of 30 mgKOH/g or more and 90 mgKOH/g or less, and wherein the dispersant contains a basic dispersant having a basic nitrogen-containing group, and wherein the insulating liquid contains 50% by mass or more of a saturated fatty acid ester which is an ester of a saturated fatty acid and an alcohol having 3 or more carbon atoms. Therefore, it is the same as the liquid developer of a first embodiment, except that the number of carbon atoms of the saturated fatty acid in the saturated fatty acid ester is not limited, and the number of carbon atoms is preferably 8 or more and 16 or less, that the acid value of the polyester-based resin and the preferred content of the tricarboxylic or higher polycarboxylic acid compound are within the following ranges, and that the dispersant contains a basic dispersant having a basic nitrogen-containing group.

In the third embodiment, the acid value of the polyester-based resin is 30 mgKOH/g or more, preferably 40 mgKOH/g or more, and more preferably 50 mgKOH/g or more, from the viewpoint of adsorbability of the dispersant to the toner particles, and the acid value is 90 mgKOH/g or less, preferably 80 mgKOH/g or less, and more preferably 70 mgKOH/g or less, from the viewpoint of dispersion stability of the toner particles.

In addition, the content of the tricarboxylic or higher polycarboxylic acid compound in the carboxylic acid component is preferably 5% by mol or more, more preferably 10% by mol or more, even more preferably 20% by mol or more, and even more preferably 25% by mol or more, from the viewpoint of adsorbability of the dispersant to the toner particles, and the content is preferably 60% by mol or less, more preferably 50% by mol or less, and even more preferably 35% by mol or less, from the viewpoint of improving dispersion stability of the toner particles, thereby improving storage stability.

The present invention will be described hereinbelow more specifically by the Examples, without intending to limit the present invention to these Examples. The physical properties of the resins and the like were measured in accordance with the following methods.

[Softening Point of Resin]

Using a flow tester “CFT-500D,” manufactured by Shimadzu Corporation, a 1 g sample is extruded through a nozzle having a diameter of 1 mm and a length of 1 mm with applying a load of 1.96 MPa thereto with a plunger, while heating the sample at a heating rate of 6° C./min. The softening point refers to a temperature at which half of the sample flows out, when plotting a downward movement of the plunger of the flow tester against temperature.

[Glass Transition Temperature of Resin]

Using a differential scanning calorimeter “DSC210,” manufactured by Seiko Instruments Inc., a 0.01 to 0.02 g sample is weighed out in an aluminum pan, heated to 200° C., and cooled from that temperature to 0° C. at a cooling rate of 10° C./min. Next, the temperature of the sample is raised at a heating rate of 10° C./min to measure endothermic peaks. A temperature of an intersection of the extension of the baseline of equal to or lower than the highest temperature of endothermic peak and the tangential line showing the maximum inclination between the kick-off of the peak and the top of the peak is defined as a glass transition temperature.

[Acid Value of Resin]

The acid value is determined by a method according to JIS K0070:1992 except that only the determination solvent is changed from a mixed solvent of ethanol and ether as prescribed in JIS K0070 to a mixed solvent of acetone and toluene in a volume ratio of acetone:toluene=1:1.

[Volume-Median Particle Size of Toner Particles Before Mixing with Insulating Liquid]

Measuring Apparatus: Coulter Multisizer II, manufactured by Beckman Coulter, Inc.

### Aperture Diameter: 100 μm

Analyzing Software: Coulter Multisizer AccuComp Ver. 1.19, manufactured by Beckman Coulter, Inc.
Electrolytic Solution: Isotone II, manufactured by Beckman Coulter, Inc.
Dispersion: EMULGEN 109P, manufactured by Kao Corporation, polyoxyethylene lauryl ether, HLB (Griffin): 13.6, is dissolved in the above electrolytic solution to adjust to a concentration of 5% by mass to provide a dispersion.
Dispersion Conditions: Ten milligrams of a measurement sample is added to 5 mL of the above dispersion, and the mixture is dispersed for 1 minute with an ultrasonic disperser (name of machine: US-1, manufactured by SND Co., Ltd., output: 80 W). Thereafter, 25 mL of the above electrolytic solution is added to the dispersion, and further dispersed with the ultrasonic disperser for 1 minute, to prepare a sample dispersion.
Measurement Conditions: The above sample dispersion is added to 100 mL of the above electrolytic solution to adjust to a concentration at which particle sizes of 30,000 particles can be measured in 20 seconds, and the 30,000 particles are measured, and a volume-median particle size D₅₀ is obtained from the particle size distribution.

[Number-Average Molecular Weight (Mn) of Raw Materials for Basic Nitrogen-Containing Group]

The number-average molecular weight is obtained by measuring a molecular weight distribution in accordance with a gel permeation chromatography (GPC) method as shown hereinbelow.

### (1) Preparation of Sample Solution

A sample is dissolved in a solution prepared by dissolving Na₂SO₄ in an aqueous 1% acetic acid solution at 0.15 mol/L so as to have a concentration of 0.2 g/100 mL. Next, this solution is filtered with a fluororesin filter “FP-200,” manufactured by Sumitomo Electric Industries, Ltd., having a pore size of 0.2 μm, to remove insoluble components, to provide a sample solution.

### (2) Molecular Weight Measurements

Using the following measurement apparatus and analyzing column, the measurement is taken by allowing a solution prepared by dissolving Na₂SO₄ in an aqueous 1% acetic acid solution at 0.15 mol/L to flow through a column as an eluent at a flow rate of 1 mL per minute, stabilizing the column in a thermostat at 40° C., and loading 100 μL of a sample solution thereto. The molecular weight of the sample is calculated based on the previously drawn calibration curve. At this time, a calibration curve which is drawn from several kinds of standard pullulans, manufactured by SHOWA DENKO CORPORATION, P-5 (5.9×10³), P-50 (4.73×10⁴), P-200 (2.12×10⁵), and P-800 (7.08×10⁵) as standard samples is used. The values within the parentheses show molecular weights.

Measurement Apparatus: HLC-8320GPC, manufactured by Tosoh Corporation
Analyzing Column: α+α-M+α-M, manufactured by Tosoh Corporation

[Number-Average Molecular Weight (Mn) of Raw Materials for Dispersible Group]

### (1) Preparation of Sample Solution

A sample is dissolved in tetrahydrofuran so as to have a concentration of 0.5 g/100 mL. Next, this solution is filtered with a fluororesin filter “FP-200,” manufactured by Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, and stabilizing the column in a thermostat at 40° C., and loading 100 μL of a sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1.09×10⁶) as standard samples is used. The values within parentheses show molecular weights.

Measurement Apparatus: HLC-8220GPC, manufactured by Tosoh Corporation
Analyzing Column: GMHXL+G3000HXL, manufactured by Tosoh Corporation.

[Number-Average Molecular Weight (Mn) and Weight-Average Molecular Weight (Mw) of Dispersant]

### (1) Example A Series

### <Dispersants A and B>

The molecular weight distribution is measured by gel permeation chromatography (GPC) method detailed below to obtain a number-average molecular weight (Mn) and a weight-average molecular weight (Mw).

### (1) Preparation of Sample Solution

A dispersant is dissolved in chloroform so as to have a concentration of 0.2 g/100 mL. Next, this solution is filtered with a fluororesin filter “FP-200,” manufactured by Sumitomo Electric Industries, Ltd., having a pore size of 0.2 μm, to remove insoluble components, to provide a sample solution.

### (2) Molecular Weight Measurements

Using the following measurement apparatus and analyzing column, the measurement is taken by allowing a chloroform solution of 1.00 mmol/L FARMIN DM2098 manufactured by Kao Corporation to flow through a column as an eluent at a flow rate of 1 mL per minute, stabilizing the column in a thermostat at 40° C., and loading a 100 μl sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-5000 (5.97×10³), F-2 (1.81×10⁴), F-10 (9.64×10⁴), and F-40 (4.27×10⁵) as standard samples is used. The values within the parentheses show molecular weights.

Measurement Apparatus: HLC-8220GPC, manufactured by Tosoh Corporation
Analyzing Column: K-804L, manufactured by SHOWA DENKO CORPORATION

### <Dispersant C>

The molecular weight distribution is measured by gel permeation chromatography (GPC) method in accordance with the following method to obtain a number-average molecular weight (Mn) and a weight-average molecular weight (Mw).

### (1) Preparation of Sample Solution

A dispersant (one in which an insulating liquid is distilled off from the dispersant solution) is dissolved in tetrahydrofuran so as to have a concentration of 0.5 g/100 mL. Next, this solution is filtered with a fluororesin filter “FP-200,” manufactured by Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, and stabilizing the column in a thermostat at 40° C., and loading 100 μL of a sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1.09×10⁶) as standard samples is used. The values within parentheses show molecular weights.

Measurement Apparatus: HLC-8220GPC, manufactured by Tosoh Corporation
Analyzing Column: TSKgel GMHXL+TSKgel G3000HXL, manufactured by Tosoh Corporation.

### (2) Example B Series

### <Dispersants A to C>

The molecular weight distribution is measured by gel permeation chromatography (GPC) method in accordance with the following method to obtain a number-average molecular weight (Mn) and a weight-average molecular weight (Mw).

### (1) Preparation of Sample Solution

A dispersant (one in which an insulating liquid is distilled off from the dispersant solution) is dissolved in tetrahydrofuran so as to have a concentration of 0.5 g/100 mL. Next, this solution is filtered with a fluororesin filter “FP-200,” manufactured by Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, and stabilizing the column in a thermostat at 40° C., and loading 100 μL of a sample solution thereto. The molecular weight of the sample is calculated based on the previously drawn calibration curve. At this time, a calibration curve which is drawn from several kinds of monodisperse polystyrenes, manufactured by Tosoh Corporation, A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1.09×10⁶) as standard samples is used. The values within parentheses show molecular weights.

Measurement Apparatus: HLC-8220GPC, manufactured by Tosoh Corporation
Analyzing Column: TSKgel GMHXL+TSKgel G3000HXL, manufactured by Tosoh Corporation.

### <Dispersants D to F>

The dispersants are measured in the same manner as those of Dispersants A and B of the Example A Series.

### (3) Example C Series

### <Dispersant A>

The dispersant is measured in the same manner as those of Dispersants A and B of the Example A Series.

[Conductivity of Insulating Liquid and Liquid Developer]

A 40-mL glass sample vial “Vial with screw cap, No. 7,” manufactured by Maruemu Corporation is charged with 25 g of a sample. The conductivity is determined by immersing an electrode in an insulating liquid, taking 20 measurements for conductivity at 25° C. with a non-aqueous conductivity meter “DT-700,” manufactured by Dispersion Technology, Inc., and calculating an average thereof. The smaller the numerical figures, the higher the resistance.

[Boiling Point of Insulating Liquid]

Using a differential scanning calorimeter “DSC210,” manufactured by Seiko Instruments Inc., a 6.0 to 8.0 g sample is weighed out in an aluminum pan, and the temperature of the sample is raised to 350° C. at a heating rate of 10° C./min to measure endothermic peaks. The highest temperature side of the endothermic peak is defined as a boiling point.

[Viscosities at 25° C. of Insulating Liquid and Liquid Developer]

A 10-mL glass sample vial with screw cap is charged with 6 to 7 mL of a measurement solution, and a viscosity at 25° C. is measured with a torsional oscillation type viscometer “VISCOMATE VM-10A-L,” manufactured by SEKONIC CORPORATION, having a detection terminal made of titanium, and a diameter of 8 mm by fixing the vial with a screw cap at a position that a liquid surface would be located 15 mm above a tip end of the detection terminal.

[Solid Content Concentrations of Dispersion of Toner Particles and Liquid Developer]

Ten parts by mass of a sample is diluted with 90 parts by mass of hexane, and the dilution is spun with a centrifuge “3-30KS,” manufactured by Sigma at a rotational speed of 25,000 r/min for 20 minutes. After allowing the mixture to stand, the supernatant is removed by decantation, the mixture is then diluted with 90 parts by mass of hexane, and the dilution is again centrifuged under the same conditions as above. The supernatant is removed by decantation, and a lower layer is then dried with a vacuum dryer at 0.5 kPa and 40° C. for 8 hours. The solid content concentration is calculated according to the following formula:

$$\begin{matrix}\begin{matrix}Solid Content \\ Concentration ,\end{matrix} \\ \% by Mass\end{matrix} = \frac{Mass of Residues After Drying}{\begin{matrix}Mass of Sample , Corresponding to \\ 10 Parts by Mass Portion\end{matrix}} \times 100 \qquad [ Math Formula 1 ]$$

[Volume-Median Particle Size D₅₀ of Toner Particles in Liquid Developer]

A volume-median particle size D₅₀ is determined with a laser diffraction/scattering particle size measurement instrument “Mastersizer 2000,” manufactured by Malvern Instruments, Ltd., by charging a cell for measurement with Isopar L, manufactured by Exxon Mobile Corporation, isoparaffin, viscosity at 25° C. of 1 mPa·s, under conditions that a particle refractive index is 1.58, imaginary part being 0.1, and a dispersion medium refractive index is 1.42, at a concentration that gives a scattering intensity of from 5 to 15%.

[Glass Transition Temperature (Tg) of Toner Particles in Liquid Developer]

Using a differential scanning calorimeter “DSC210,” manufactured by Seiko Instruments Inc., a 0.025 to 0.035 g liquid developer is weighed out in an aluminum pan, and the temperature of the sample is raised from 0° to 100° C. at a heating rate of 10° C./min to measure endothermic peaks. A temperature of an intersection of the extension of the baseline of equal to or lower than the highest temperature of endothermic peak and the tangential line showing the maximum inclination between the kick-off of the peak and the top of the peak is defined as a glass transition temperature.

### Example A Series

Production Example 1 of Resin

A 10-L four-neck flask equipped with a nitrogen inlet tube, a dehydration tube, a stirrer, and a thermocouple was charged with raw material monomers and an esterification catalyst as listed in Table A-1. The contents were heated with a mantle heater to 180° C. and then heated to 220° C. over 10 hours, and a mixture was reacted at 220° C. Further, the mixture was reacted at 8.3 kPa until a softening point reached as listed in Table A-1, to provide a polyester resin (Resin A) having physical properties as shown in Table A-1.

Production Example 2 of Resin

A 10-L four-neck flask equipped with a nitrogen inlet tube, a dehydration tube, a stirrer, and a thermocouple was charged with raw material monomers other than trimellitic anhydride, an esterification catalyst, and a polymerization inhibitor as listed in Table A-1. The contents were heated with a mantle heater from 180° to 200° C. over 1 hour, and a mixture was reacted at 200° C. Thereafter, trimellitic anhydride was added thereto, and the mixture was reacted at 200° C. until a softening point reached as listed in Table A-1, to provide a polyester resin (Resin B) having physical properties as shown in Table A-1.

TABLE A-1

| | | Resin A | Resin B |
|---|---|---|---|
| Raw Material | 1,2-Propanediol | 3,528 g | — |
| Monomers | | (100) | |
| | BPA-PO¹⁾ | — | 3,747 g |
| | | | (50) |
| | BPA-EO²⁾ | — | 3,479 g |
| | | | (50) |
| | Terephthalic Acid | 6,472 g | 2,346 g |
| | | (84) | (66) |
| | Fumaric Acid | — | 99 g |
| | | | (4) |
| | Trimellitic Anhydride | — | 329 g |
| | | | (8) |
| Esterification | Tin(II) 2-Ethylhexanoate | 50 g | 50 g |
| Catalyst | | | |
| Polymerization | 4-t-Butyl Catechol | — | 5 g |
| Inhibitor | | | |
| Physical Properties | Softening Point, ° C. | 91 | 92 |
| of Resin | Glass Transition | 50 | 51 |
| | Temperature, ° C. | | |
| | Acid Value, mgKOH/g | 9 | 7 |

Note)
The numerical figures inside the parentheses in the raw material monomers are expressed by a molar ratio when a total number of moles of the alcohol component is defined as 100.
¹⁾BPA-PO: Polyoxypropylene(2.2)-2,2-bis(4-hydroxyphenyl)propane
²⁾BPA-EO: Polyoxyethylene(2.2)-2,2-bis(5-hydroxyphenyl)propane

Production Example 1 of Dispersant

A 2-L four-neck flask equipped with a condenser, a nitrogen inlet tube, a stirrer, a dehydration tube, and a thermocouple was charged with a polyalkyleneimine as listed in Table A-2, and the internal of the reaction vessel was replaced with nitrogen gas. While stirring, a solution prepared by dissolving a polyisobutene succinic anhydride (PIBSA) as listed in Table A-2 in xylene was added dropwise thereto at 25° C. over one hour. After the termination of the dropwise addition, the mixture was held at 25° C. for 30 minutes. Thereafter, the internal of the reaction vessel was heated to 150° C. and held thereat for one hour, and then heated to 160° C. and held thereat for one hour. The pressure was reduced to 8.3 kPa at 160° C. to distill off the solvent. The time point at which a peak of acid anhydride ascribed to PIBSA (1,780 cm⁻¹) disappeared and a peak ascribed to imide bonding (1,700 cm⁻¹) was generated according to the IR analysis was defined as a reaction terminal point, to provide Dispersant A having physical properties as shown in Table A-2.

TABLE A-2

| | | Dispersant |
|---|---|---|
| | | A |
| Polyalkyleneimine | Polyethyleneimine 600, manufactured | 20 g |
| | by JUNSEI CHEMICAL CO., LTD. | |
| | Structure | Branched |
| | Number-Average Molecular Weight | 1,500 |
| Polyisobutene | OLOA ® 15500, | 197 g |
| succinic anhydride | manufactured by Chevron Oronite, | |
| | effective content: 78% by mass | |
| | Number of Carbon Atoms of Polyolefin | 69 |
| | Unit | |
| | Number-Average Molecular Weight | 1,100 |
| Solvent | Xylene | 217 g |
| Physical Properties | Number-Average Molecular Weight | 6,600 |
| of Dispersant | Weight-Average Molecular Weight | 76,700 |

Production Example 2 of Dispersant

A 2-L four-neck flask equipped with a condenser, a nitrogen inlet tube, a stirrer, and a thermocouple was charged with 100 g of a solvent methyl ethyl ketone, and the internal of the reaction vessel was replaced with nitrogen gas. The internal of the reaction vessel was heated to 80° C., and a mixture of raw material monomers and a polymerization initiator as listed in Table A-3 was added dropwise over two hours to carry out a polymerization reaction. After the termination of the dropwise addition, the mixture was further reacted at 80° C. for 3 hours. The solvent was distilled off at 80° C., to provide Dispersant C made of a copolymer having physical properties as shown in Table A-3.

TABLE A-3

| | | Dispersant |
|---|---|---|
| | | C |
| Raw Material | Dimethylaminoethyl methacrylate, | 20 g |
| Monomers | manufactured by Wako Pure Chemical | |
| | Industries, Ltd. | |
| | 1-Octadecyl methacrylate [stearyl | 80 g |
| | methacrylate], manufactured by | |
| | Wako Pure Chemical Industries, Ltd. | |
| Polymerization | 2,2′-Azobis(2,4-dimethylvaleronitrile), | 3 g |
| Initiator | manufactured by Wako Pure Chemical | |
| | Industries, Ltd. | |
| Physical Properties | Number-Average Molecular Weight | 4,700 |
| of Dispersant | Weight-Average Molecular Weight | 15,000 |

### Examples 1 to 7 and Comparative Examples 1 to 5

Eighty parts by mass of a resin binder as listed in Table A-5 and 20 parts by mass of a colorant “ECB-301” manufactured by DAINICHISEIKA COLOR & CHEMICALS MFG. CO., LTD., Phthalocyanine Blue 15:3, were previously mixed while stirring with a 20-L Henschel mixer for 3 minutes at a rotational speed of 1,500 r/min (peripheral speed 21.6 m/sec). Thereafter, the mixture was melt-kneaded under the conditions given below.

[Melt-Kneading Conditions]

A continuous twin open-roller type kneader “Kneadex,” manufactured by NIPPON COKE & ENGINEERING CO., LTD. having an outer diameter of roller of 14 cm and an effective length of roller of 55 cm was used. The operating conditions of the continuous twin open-roller type kneader were a rotational speed of a high-rotation roller (front roller) of 75 r/min (peripheral speed of 32.4 m/min), a rotational speed of a low-rotation roller (back roller) of 35 r/min (peripheral speed of 15.0 m/min), and a gap between the rollers at an end of the kneaded product supplying side of 0.1 mm. The temperatures of the heating medium and the cooling medium inside the rollers were as follows. The high-rotation roller had a temperature at the raw material supplying side of 90° C., and a temperature at the kneaded product-discharging side of 85° C., and the low-rotation roller had a temperature at the raw material supplying side of 35° C., and a temperature at the kneaded product-discharging side of 35° C. In addition, the feeding rate of the raw material mixture to the kneader was 10 kg/h, and the average residence time in the kneader was about 3 minutes.

The kneaded product obtained above was roll-cooled with a cooling roller, and the cooled product was then roughly pulverized with a hammer-mill to a size of 1 mm or so. The roughly pulverized product obtained was finely pulverized and classified with an air jet type jet mill “IDS,” manufactured by Nippon Pneumatic Mfg. Co., Ltd., to provide toner particles having a volume-median particle size D₅₀ of 10 μm.

A 1-L polyethylene vessel was charged with 35 parts by mass of the toner particles obtained, 63.95 parts by mass of an insulating liquid as listed in Table A-5 (except for Example 4 being 62.9 parts by mass), and 1.05 parts by mass of a dispersant as listed in Table A-5 (except for Example 4 being 2.1 parts by mass) (3 parts by mass based on 100 parts by mass of the toner particles). The contents were stirred with “T.K. ROBOMIX,” manufactured by PRIMIX Corporation, under ice-cooling at a rotational speed of 7,000 r/min for 30 minutes, to provide a dispersion of toner particles, a solid content concentration of which was 36% by mass.

Next, the dispersion of toner particles obtained was subjected to wet-milling for 4 hours with 6 vessels-type sand mill “TSG-6,” manufactured by AIMEX CO., LTD., at a rotational speed of 1,300 r/min (peripheral speed 4.8 m/see) using zirconia beads having a diameter of 0.8 mm at a volume filling ratio of 60% by volume to a volume-median particle size D₅₀ as listed in Table A-5. The beads were removed by filtration, and 44 parts by mass of the insulating liquid as listed in Table A-5 was added, based on 100 parts by mass of the filtrate, to dilute the filtrate, to provide a liquid developer, a solid content concentration of which was adjusted to 25% by mass, the liquid developer having physical properties as shown in Table A-5. In Comparative Examples 1 and 4, the dispersion of toner particles was solidified immediately after the beginning of wet-milling, so that a liquid developer could not be obtained.

The details of the insulation liquids used in Examples and Comparative Examples (including those of Example B series and Example C series) are as follows.

TABLE A-4
(Common for Example A Series, Example B Series, and Example C Series)

| | | | | Boiling | Viscosity |
|---|---|---|---|---|---|
| | Merchandize Name | Manufacturer | Conductivity, | Point, | at 25° C., |
| | and Compound Name | and the like | S/m | ° C. | mPa · s |
| Hexyl | EXCEPARL HL | Kao Corporation | 4.76 × 10⁻¹¹ | 333 | 5 |
| laurate | | | | | |
| Isopropyl | EXCEPARL IPP | Kao Corporation | 9.55 × 10⁻¹² | 332 | 6 |
| palmitate | | | | | |
| Isopropyl | EXCEPARL IPM | Kao Corporation | 3.05 × 10⁻¹¹ | 304 | 4 |
| myristate | | | | | |
| Methyl | EXCEPARL ML-85 | Kao Corporation | 5.29 × 10⁻¹¹ | 262 | 3 |
| laurate | | | | | |
| Methyl | EXCEPARL M-OL | Kao Corporation | 6.20 × 10⁻¹¹ | 351 | 5 |
| oleate | | | | | |
| Liquid | Lytol | Sonneborn | 8.60 × 10⁻¹² | 314 | 5 |
| paraffin | | | | | |
| Ethyl | Ethyl laurate | Tokyo Chemical | 4.96 × 10⁻¹¹ | 275 | 3 |
| laurate | | Industry Co., Ltd. | | | |
| Butyl | Butyl oleate | Wako Pure | 2.93 × 10⁻¹¹ | >350 | 7 |
| oleate | | Chemical Industries, | | | |
| | | Ltd. | | | |

### Test Example 1—Storage Stability

A 10 mL-glass vial with screw cap was charged with 5 g of a liquid developer, and then stored in a thermostat held at 50° C. for 15 hours. The volume-median particle sizes D₅₀ of the toner particles before and after the storage were determined, and the storage stability was evaluated from a value (%) obtained by [D₅₀ After Storage]/[D₅₀ Before Storage]×100. The results are shown in Table A-5. It is shown that the more the numerical values approximates 100%, the more excellent the storage stability.

### Test Example 2—Low-Temperature Fusing Ability

A liquid developer was dropped on “POD Gloss Coated Paper” manufactured by Oji Paper Co., Ltd., and a thin film was produced with a wire bar, so that the mass on a dry basis was 1.2 g/m².

The produced thin film was held in a thermostat at 80° C. for 10 seconds, and fusing was then carried out at a fusing roller temperature set at 90° C. and a fusing speed of 140 mm/sec, with an external fuser, which was a fuser taken out to the external of “OKI MICROLINE 3010,” manufactured by Oki Data Corporation. Thereafter, the same procedures were carried out with setting a fusing roller temperature at 95° C. The fusing treatment as mentioned above was carried out for unfused images at each temperature, while raising the fusing roller temperature up to 140° C. with an increment of 5° C., to provide fused images.

The fused images obtained were adhered to a mending tape “Scotch Mending Tape 810,” manufactured by 3M, width of 18 mm, the tape was pressed with a roller so as to apply a load of 500 g thereto, and the tape was then removed. The optical densities before tape adhesion and after tape removal were measured with a colorimeter “GretagMacbeth Spectroeye,” manufactured by Gretag. The fused image-printed portions were measured at 3 points each, and an average thereof was calculated as an optical density. A fusing ratio (%) was calculated from a value obtained by

[Optical Density After Removal]/[Optical Density Before Adhesion]×100,

and a temperature of the fusing roller at which a fusing ratio initially reaches 90% or more is defined as a lowest fusing temperature to evaluate low-temperature fusing ability. The results are shown in Table A-5. It is shown that the smaller the numerical value, the more excellent the low-temperature fusing ability.

TABLE A-5

| | | | | | Liquid Developer | | | | | | |
|---|---|---|---|---|---|---|---|---|---|---|---|
| | | | | | | | | D₅₀ of | D₅₀ of | | |
| | | | | | | | | Toner | Toner | | Low- |
| | | | | | Tg of | | | Particles | Particles | Storage | Temp. |
| | | | | | Toner | Conduc- | Vis- | Before | After | Sta- | Fusing |
| | Resin | | | | Particles, | tivity, | cosity, | Storage, | Storage, | bility, | Ability, |
| | Binder | Insulating Liquid | | Dispersant | ° C. | S/m | mPa · s | μm | μm | % | ° C. |
| Ex. 1 | Resin A | EXCEPARL HL | Hexyl laurate | Dispersant A | 28 | 8.98 × 10⁻⁹ | 15 | 2.0 | 2.0 | 100 | 100 |
| Ex. 2 | Resin A | EXCEPARL IPP | Isopropyl | Dispersant A | 46 | 7.54 × 10⁻⁹ | 21 | 2.0 | 2.0 | 100 | 110 |
| | | | palmitate | | | | | | | | |
| Ex. 3 | Resin A | EXCEPARL IPM | Isopropyl | Dispersant A | 25 | 8.35 × 10⁻⁹ | 18 | 2.1 | 2.2 | 105 | 100 |
| | | | myristate | | | | | | | | |
| Ex. 4 | Resin A | EXCEPARL HL | Hexyl laurate | Dispersant B | 29 | 2.43 × 10⁻⁸ | 18 | 2.0 | 2.0 | 100 | 100 |
| Ex. 5 | Resin B | EXCEPARL HL | Hexyl laurate | Dispersant A | 21 | 6.92 × 10⁻⁹ | 25 | 2.2 | 2.4 | 109 | 100 |
| Ex. 6 | Resin A | EXCEPARL HL | Hexyl laurate | Dispersant C | 27 | 3.45 × 10⁻⁹ | 29 | 2.4 | 2.8 | 117 | 105 |
| Ex. 7 | Resin A | EXCEPARL HL/ | Hexyl laurate / | Dispersant A | 41 | 8.76 × 10⁻¹⁰ | 17 | 2.1 | 2.1 | 100 | 110 |
| | | Lytol = 50/50 | Liquid | | | | | | | | |
| | | (mass ratio) | paraffin = | | | | | | | | |
| | | | 50/50 | | | | | | | | |
| | | | (mass ratio) | | | | | | | | |
| Comp. | Resin A | EXCEPARL | Methyl laurate | Dispersant A | Unable to carry out wet-milling because of being solidified | | | | | | |
| Ex. 1 | | ML-85 | | | | | | | | | |
| Comp. | Resin A | EXCEPARL | Methyl oleate | Dispersant A | 10 | 1.12 × 10⁻⁸ | 45 | 6.2 | 10.6 | 171 | 130 |
| Ex. 2 | | M-OL | | | | | | | | | |
| Comp. | Resin A | Lytol | Liquid paraffin | Dispersant A | 50 | 2.01 × 10⁻¹⁰ | 20 | 2.1 | 2.1 | 100 | 120 |
| Ex. 3 | | | | | | | | | | | |
| Comp. | Resin A | Ethyl laurate | Ethyl laurate | Dispersant A | Unable to carry out wet-milling because of being solidified | | | | | | |
| Ex. 4 | | | | | | | | | | | |
| Comp. | Resin A | Butyl oleate | Butyl oleate | Dispersant A | 34 | 4.43 × 10⁻⁸ | 26 | 2.1 | 2.2 | 105 | 130 |
| Ex. 5 | | | | | | | | | | | |

Dispersant B: “SOLSPARSE 11200,” manufactured by Lubrizol Corporation, a condensate of a polyethyleneimine and a carboxylic acid (a condensed product of 12-hydroxystearic acid, average degree of polymerization: 7.0). Mw: 10,400, effective content: 50% by mass

It can be seen from the above results that the liquid developers of Examples 1 to 7 have smaller particle sizes, lowered viscosity, and excellent storage stability and low-temperature fusing ability.

On the other hand, in Comparative Example 1 or 4 where methyl ester or ethyl ester is used as a saturated fatty acid ester, the dispersion of toner particles is solidified due to poor dispersion of the toner particles in the course of the production, so that a liquid developer cannot be obtained. In addition, in Comparative Example 2 where an unsaturated fatty acid ester is used, the liquid developer has increased viscosity due to aggregation of the toner particles, thereby making it unsatisfactory in both storage stability and low-temperature fusing ability. In the liquid developer of Comparative Example 3 where a liquid paraffin is used and that of Comparative Example 5 where an unsaturated fatty acid ester which is an ester of an unsaturated fatty acid having 18 carbon atoms and an alcohol having 4 carbon atoms is used lack low-temperature fusing ability.

### Example B Series

Production Example 1 of Resin

A 10-L four-neck flask equipped with a nitrogen inlet tube, a dehydration tube, a stirrer, and a thermocouple was charged with raw material monomers and an esterification catalyst as listed in Table B-1. The contents were heated with a mantle heater to 180° C. and then heated to 220° C. over 10 hours, and a mixture was reacted at 220° C. Further, the mixture was reacted at 8.3 kPa until a softening point reached as listed in Table B-1, to provide a polyester resin (Resin A) having physical properties as shown in Table B-1.

TABLE B-1

| | | Resin A |
|---|---|---|
| Raw Material | 1,2-Propanediol | 3,528 g |
| Monomers | | (100) |
| | Terephthalic Acid | 6,472 g |
| | | (84) |
| Esterification | Tin(II) 2-Ethylhexanoate | 50 g |
| Catalyst | | |
| Physical Properties | Softening Point, ° C. | 91 |
| of Resin | Glass Transition | 50 |
| | Temperature, ° C. | |
| | Acid Value, mgKOH/g | 9 |

Note)
The numerical figures inside the parentheses in the raw material monomoers are expressed by a molar ratio when a total number of moles of the alcohol compnent is defined as 100.

Production Example 1 of Dispersants

A 2-L four-neck flask equipped with a condenser, a nitrogen inlet tube, a stirrer, and a thermocouple was charged with 100 g of a solvent methyl ethyl ketone, and the internal of the reaction vessel was replaced with nitrogen gas. The internal of the reaction vessel was heated to 80° C., and a mixture of raw material monomers and a polymerization initiator as listed in Table B-2 was added dropwise thereto over two hours to carry out a polymerization reaction. After the termination of the dropwise addition, the mixture was further reacted at 80° C. for three hours. The solvent was distilled off at 80° C., to provide each of Dispersants A to C having physical properties as shown in Table B-2.

TABLE B-2

| | | Dispersant | Dispersant | Dispersant |
|---|---|---|---|---|
| | | A | B | C |
| Raw Material | Dimethylaminoethyl methacrylate | 30 g | 16 g | 50 g |
| Monomers | [DMAEMA], manufactured by | | | |
| | Wako Pure Chemical Industries, Ltd. | | | |
| | KP-2012, manufactured by Shin-Etsu | 70 g | 84 g | — |
| | Chemical Col, Ltd., Mw: 5,300 | | | |
| | X-22-174ASX, manufactured by | — | — | 50 g |
| | Shin-Etsu Chemical Col, Ltd., | | | |
| | Mw: 1,300 | | | |
| Polymerization | 2,2′-Azobis(2,4-dimethylvaleronitrile), | 0.6 g | 0.6 g | 0.6 g |
| Initiator | manufactured by Wako Pure Chemical | | | |
| | Industries, Ltd. | | | |
| Physical Properties | Number-Average Molecular Weight | 5,500 | 4,500 | 7,100 |
| of Dispersant | Weight-Average Molecular Weight | 54,000 | 53,000 | 39,000 |

Production Example 2 of Dispersant

A 1-L four-neck flask equipped with a condenser, a nitrogen inlet tube, a stirrer, a dehydration tube, and a thermocouple was charged with a polyalkyleneimine, an epoxy-based compound having a polysiloxane chain, and ethanol as listed in Table B-3, and the mixture was heated to 75° C. and stirred for 12 hours. Thereafter, ethanol was removed at 75° C. and 8.3 kPa. The time point at which a peak ascribed to an epoxy group (2.5 ppm) disappeared according to the NMR analysis was defined as a reaction terminal point, to provide Dispersant D.

Production Example 3 of Dispersant

A 2-L four-neck flask equipped with a condenser, a nitrogen inlet tube, a stirrer, a dehydration tube, and a thermocouple was charged with a polyalkyleneimine as listed in Table B-3, and the internal of the reaction vessel was replaced with nitrogen gas. While stirring, a solution prepared by dissolving a polyisobutene succinic anhydride (PIBSA) as listed in Table B-3 in xylene was added dropwise thereto at 25° C. over one hour. After the termination of the dropwise addition, the mixture was held at 25° C. for 30 minutes. Thereafter, the internal of the reaction vessel was heated to 150° C. and held thereat for one hour, and then heated to 160° C. and held thereat for one hour. The pressure was reduced to 8.3 kPa at 160° C. to distill off the solvent. The time point at which a peak of acid anhydride ascribed to PIBSA (1,780 cm⁻¹) disappeared and a peak ascribed to imide bonding (1,700 cm⁻¹) was generated according to the IR analysis was defined as a reaction terminal point, to provide Dispersant E having physical properties as shown in Table B-3.

TABLE B-3

| | | Dispersant | Dispersant |
|---|---|---|---|
| | | D | E |
| Polyalkyleneimine | Polyethyleneimine 600, manufactured | 7 g | 20 g |
| | by JUNSEI CHEMICAL CO., LTD. | | |
| | Structure | Branched | Branched |
| | Number-Average Molecular Weight | 1,500 | 1,500 |
| Epoxy-based | X22-173BX, manufactured by Shin- | 150 g | — |
| compound having | Etsu Chemical Col, Ltd. | | |
| polysiloxane | Number-Average Molecular Weight | 2,000 | — |
| chain | | | |
| Polyisobutene | OLOA ® 15500, manufactured by | — | 197 g |
| succinic anhydride | Chevron Oronite, effective content: | | |
| | 78% by mass | | |
| | Number of Carbon Atoms of | — | 69 |
| | Polyolefin Unit | | |
| | Number-Average Molecular Weight | — | 1,100 |
| Solvent | Ethanol | 150 g | — |
| | Xylene | — | 217 g |
| Physical Properties | Number-Average Molecular Weight | 9,800 | 6,600 |
| of Dispersant | Weight-Average Molecular Weight | 17,200 | 76,700 |

Note)
X22-173BX: Compound represented by the formula (V) (R⁴: a glycidyl group, m: 24)

### Examples 1 to 3

Eighty parts by mass of a resin binder as listed in Table B-4 and 20 parts by mass of a colorant “ECB-301” manufactured by DAINICHISEIKA COLOR & CHEMICALS MFG. CO., LTD., Phthalocyanine Blue 15:3, were previously mixed while stirring with a 20-L Henschel mixer for 3 minutes at a rotational speed of 1,500 r/min (peripheral speed 21.6 m/sec). Thereafter, the mixture was melt-kneaded under the conditions given below.

[Melt-Kneading Conditions]

A continuous twin open-roller type kneader “Kneadex,” manufactured by NIPPON COKE & ENGINEERING CO., LTD. having an outer diameter of roller of 14 cm and an effective length of roller of 55 cm was used. The operating conditions of the continuous twin open-roller type kneader were a rotational speed of a high-rotation roller (front roller) of 75 r/min (peripheral speed of 32.4 m/min), a rotational speed of a low-rotation roller (back roller) of 35 r/min (peripheral speed of 15.0 m/min), and a gap between the rollers at an end of the kneaded product supplying side of 0.1 mm. The temperatures of the heating medium and the cooling medium inside the rollers were as follows. The high-rotation roller had a temperature at the raw material supplying side of 90° C., and a temperature at the kneaded product-discharging side of 85° C., and the low-rotation roller had a temperature at the raw material supplying side of 35° C., and a temperature at the kneaded product-discharging side of 35° C. In addition, the feeding rate of the raw material mixture to the kneader was 10 kg/h, and the average residence time in the kneader was about 3 minutes.

The kneaded product obtained above was roll-cooled with a cooling roller, and the cooled product was then roughly pulverized with a hammer-mill to a size of 1 mm or so. The roughly pulverized product obtained was finely pulverized and classified with an air jet type jet mill “IDS,” manufactured by Nippon Pneumatic Mfg. Co., Ltd., to provide toner particles having a volume-median particle size D₅₀ of 10 μm.

A 1-L polyethylene vessel was charged with 35 parts by mass of the toner particles obtained, 63.42 parts by mass of an insulating liquid “EXCEPARL HL,” manufactured by Kao Corporation, and 1.58 parts by mass of a dispersant as listed in Table B-4 (4.5 parts by mass based on 100 parts by mass of the toner particles). The contents were stirred with “T.K. ROBOMIX,” manufactured by PRIMIX Corporation, under ice-cooling at a rotational speed of 7,000 r/min for 30 minutes, to provide a dispersion of toner particles, a solid content concentration of which was 36% by mass.

Next, the dispersion of toner particles obtained was subjected to wet-milling with 6 vessels-type sand mill “TSG-6,” manufactured by AIMEX CO., LTD., at a rotational speed of 1,300 r/min (peripheral speed 4.8 m/sec) using zirconia beads having a diameter of 0.8 mm at a volume filling ratio of 60% by volume to a volume-median particle size D₅₀ as listed in Table B-4. The beads were removed by filtration, and 44 parts by mass of the insulating liquid “EXCEPARL HL” was then added, based on 100 parts by mass of the filtrate, to dilute the filtrate, to provide a liquid developer, a solid content concentration of which was adjusted to 25% by mass, the liquid developer having physical properties as shown in Table B-4.

### Example 4 and Comparative Examples 1 to 5

The same procedures as in Example 1 were carried out except that an insulating liquid and a dispersant as listed in Table B-4 were used, that the amount of the basic dispersant used to be mixed with toner particles was changed to 1.05 parts by mass (3 parts by mass, based on 100 parts by mass of the toner particles), and that the amount of the insulating liquid used to be mixed with the toner particles was changed to 63.95 parts by mass, to provide a liquid developer, a solid content concentration of which was 25% by mass, the liquid developer having physical properties as shown in Table B-4. However, in Comparative Examples 1 and 4, the dispersion of toner particles was solidified immediately after the beginning of wet-milling, so that a liquid developer could not be obtained.

### Test Example 1—Storage Stability

The storage stability was evaluated in the same manner as in Test Example 1 of the Example A series. The results are shown in Table B-4.

### Test Example 2—Low-Temperature Fusing Ability

A liquid developer was dropped on “POD Gloss Coated Paper” manufactured by Oji Paper Co., Ltd., and a thin film was produced with a wire bar, so that the mass on a dry basis was 1.2 g/m².

The produced thin film was held in a thermostat at 80° C. for 10 seconds, and fusing was then carried out at a fusing roller temperature set at 70° C. and a fusing speed of 140 mm/sec, with an external fuser, which was a fuser taken out to the external of “OKI MICROLINE 3010,” manufactured by Oki Data Corporation. Thereafter, the same procedures were carried out with setting a fusing roller temperature at 75° C. The fusing treatment as mentioned above was carried out for unfused images at each temperature, while raising the fusing roller temperature up to 140° C. with an increment of 5° C., to provide fused images.

The fused images obtained were adhered to a mending tape “Scotch Mending Tape 810,” manufactured by 3M, width of 18 mm, the tape was pressed with a roller so as to apply a load of 500 g thereto, and the tape was then removed. The optical densities before tape adhesion and after tape removal were measured with a colorimeter “GretagMacbeth Spectroeye,” manufactured by Gretag. The fused image-printed portions were measured at 3 points each, and an average thereof was calculated as an optical density. A fusing ratio (%) was calculated from a value obtained by

[Optical Density After Removal]/[Optical Density Before Adhesion]×100,

and a temperature of the fusing roller at which a fusing ratio initially reaches 90% or more is defined as a lowest fusing temperature to evaluate low-temperature fusing ability. The results are shown in Table B-4. It is shown that the smaller the numerical value, the more excellent the low-temperature fusing ability.

TABLE B-4

| | | | | Liquid Developer | | | | | | |
|---|---|---|---|---|---|---|---|---|---|---|
| | | | | | | | D₅₀ of | D₅₀ of | | |
| | | | | | | | Toner | Toner | | Low- |
| | | | | Tg of | | | Particles | Particles | Storage | Temp. |
| | | | | Toner | Conduc- | Vis- | Before | After | Sta- | Fusing |
| | Resin | | | Particles, | tivity, | cosity, | Storage, | Storage, | bility, | Ability, |
| | Binder | Insulating Liquid | Dispersant | ° C. | S/m | mPa · s | μm | μm | % | ° C. |
| Ex. 1 | Resin A | Hexyl laurate | Dispersant A | 31 | 3.11 × 10⁻¹⁰ | 32 | 2.1 | 2.1 | 100 | 80 |
| Ex. 2 | Resin A | Hexyl laurate | Dispersant B | 31 | 3.45 × 10⁻¹⁰ | 36 | 2.2 | 2.2 | 100 | 85 |
| Ex. 3 | Resin A | Hexyl laurate | Dispersant C | 31 | 8.42 × 10⁻¹⁰ | 17 | 2.1 | 2.1 | 100 | 90 |
| Ex. 4 | Resin A | Hexyl laurate | Dispersant D | 31 | 6.56 × 10⁻¹⁰ | 28 | 2.1 | 2.1 | 100 | 90 |
| Comp. | Resin A | Methyl laurate | Dispersant E | Unable to carry out wet-milling because of being solidified | | | | | | |
| Ex. 1 | | | | | | | | | | |
| Comp. | Resin A | Methyl oleate | Dispersant E | 10 | 1.12 × 10⁻⁸ | 45 | 6.2 | 10.6 | 171 | 130 |
| Ex. 2 | | | | | | | | | | |
| Comp. | Resin A | Liquid paraffin | Dispersant E | 50 | 2.01 × 10⁻¹⁰ | 20 | 2.1 | 2.1 | 100 | 120 |
| Ex. 3 | | | | | | | | | | |
| Comp. | Resin A | Ethyl laurate | Dispersant E | Unable to carry out wet-milling because of being solidified | | | | | | |
| Ex. 4 | | | | | | | | | | |
| Comp. | Resin A | Butyl oleate | Dispersant E | 34 | 4.43 × 10⁻⁸ | 26 | 2.1 | 2.2 | 105 | 130 |
| Ex. 5 | | | | | | | | | | |

It can be seen from the above results that the liquid developers of Examples 1 to 4 have smaller particle sizes, lowered viscosity, and high resistance, and excellent storage stability and low-temperature fusing ability.

On the other hand, in Comparative Examples 1 to 5, a basic dispersant that is not silicone-based is used, and in Comparative Examples 1 and 4 where a methyl ester or an ethyl ester is used as a saturated fatty acid ester, the dispersion of toner particles is solidified due to dispersion failure of the toner particles in the course of production, so that the liquid developer is not obtained. In addition, in Comparative Example 2 where an unsaturated fatty acid ester is used, the liquid developer has increased viscosity due to aggregation of the toner particles, so that both storage stability and low-temperature fusing ability are insufficient, and the liquid developer of Comparative Example 3 where a liquid paraffin is used and that of Comparative Example 5 where an unsaturated fatty acid ester which is an ester of an unsaturated fatty acid having 18 carbon atoms and an alcohol having 4 carbon atoms is used lack low-temperature fusing ability.

### Example C Series

Production Example 1 of Resins

A 10-L four-neck flask equipped with a nitrogen inlet tube, a dehydration tube, a stirrer, and a thermocouple was charged with raw material monomers other than trimellitic anhydride, and an esterification catalyst as listed in Table C-1. The contents were heated with a mantle heater from 180° to 200° C. over 10 hours, and a mixture was reacted at 200° C. Thereafter, trimellitic anhydride was added thereto, and the mixture was reacted at 200° C. until a softening point reached as listed in Table C-1, to provide each of polyester resins (Resins A to D) having physical properties as shown in Table C-1.

Production Example 2 of Resin

A 10-L four-neck flask equipped with a nitrogen inlet tube, a dehydration tube, a stirrer, and a thermocouple was charged with raw material monomers and an esterification catalyst as listed in Table C-1. The contents were heated with a mantle heater to 180° C. and then heated to 220° C. over 10 hours, and a mixture was reacted at 220° C. Further, the mixture was reacted at 8.3 kPa until a softening point reached as listed in Table C-1, to provide a polyester resin (Resin E) having physical properties as shown in Table C-1.

TABLE C-1

| | | Resin | Resin | Resin | Resin | Resin |
|---|---|---|---|---|---|---|
| | | A | B | C | D | E |
| Raw Material | 1,2-Propanediol | 3,551 g | 3,499 g | 3,684 g | 3,766 g | 3,528 g |
| Monomers | | (100) | (100) | (100) | (100) | (100) |
| | Terephthalic Acid | 4,654 g | 4,203 g | 4,828 g | 5,758 g | 6,472 g |
| | | (60) | (55) | (60) | (70) | (84) |
| | Trimellitic Anhydride | 1,794 g | 2,298 g | 1,489 g | 476 g | — |
| | (TMA) | (20) | (26) | (16) | (5) | |
| Esterification | Tin(II) 2-Ethylhexanoate | 50 g | 50 g | 50 g | 50 g | 50 g |
| Catalyst | | | | | | |
| Physical | Softening Point, ° C. | 101 | 101 | 100 | 100 | 91 |
| Properties | Glass Transition | 57 | 55 | 55 | 60 | 50 |
| of Resin | Temperature, ° C. | | | | | |
| | Acid Value, mgKOH/g | 59 | 69 | 37 | 35 | 9 |

Note)
The numerical figures inside the parentheses in the raw material monomers are expressed by a molar ratio when a total number of moles of the alcohol component is defined as 100.

Production Example 1 of Dispersant

A 2-L four-neck flask equipped with a condenser, a nitrogen inlet tube, a stirrer, a dehydration tube, and a thermocouple was charged with a polyalkyleneimine as listed in Table C-2, and the internal of the reaction vessel was replaced with nitrogen gas. While stirring, a solution prepared by dissolving a polyisobutene succinic anhydride (PIBSA) as listed in Table C-2 in xylene was added dropwise thereto at 25° C. over one hour. After the termination of the dropwise addition, the mixture was held at 25° C. for 30 minutes. Thereafter, the internal of the reaction vessel was heated to 150° C. and held thereat for one hour, and then heated to 160° C. and held thereat for one hour. The pressure was reduced to 8.3 kPa at 160° C. to distill off the solvent. The time point at which a peak of acid anhydride ascribed to PIBSA (1,780 cm⁻¹) disappeared and a peak ascribed to imide bonding (1,700 cm⁻¹) was generated according to the IR analysis was defined as a reaction terminal point, to provide Dispersant A having physical properties as shown in Table C-2.

TABLE C-2

| | | Dispersant |
|---|---|---|
| | | A |
| Polyalkyleneimine | Polyethyleneimine 600, manufactured | 20 g |
| | by JUNSEI CHEMICAL CO., LTD. | |
| | Structure | Branched |
| | Number-Average Molecular Weight | 1,500 |
| Polyisobutene | OLOA ® 15500, | 197 g |
| succinic anhydride | manufactured by Chevron Oronite, | |
| | effective content: 78% by mass | |
| | Number of Carbon Atoms of Polyolefin | 69 |
| | Unit | |
| | Number-Average Molecular Weight | 1,100 |
| Solvent | Xylene | 217 g |
| Physical Properties | Number-Average Molecular Weight | 6,600 |
| of Dispersant | Weight-Average Molecular Weight | 76,700 |

### Examples 1 to 6 and Comparative Examples 1 to 5

Eighty parts by mass of a resin binder as listed in Table C-3 and 20 parts by mass of a colorant “ECB-301” manufactured by DAINICHISEIKA COLOR & CHEMICALS MFG. CO., LTD., Phthalocyanine Blue 15:3, were previously mixed while stirring with a 20-L Henschel mixer for 3 minutes at a rotational speed of 1,500 r/min (peripheral speed 21.6 m/sec). Thereafter, the mixture was melt-kneaded under the conditions given below.

[Melt-Kneading Conditions]

A continuous twin open-roller type kneader “Kneadex,” manufactured by NIPPON COKE & ENGINEERING CO., LTD. having an outer diameter of roller of 14 cm and an effective length of roller of 55 cm was used. The operating conditions of the continuous twin open-roller type kneader were a rotational speed of a high-rotation roller (front roller) of 75 r/min (peripheral speed of 32.4 m/min), a rotational speed of a low-rotation roller (back roller) of 35 r/min (peripheral speed of 15.0 m/min), and a gap between the rollers at an end of the kneaded product supplying side of 0.1 mm. The temperatures of the heating medium and the cooling medium inside the rollers were as follows. The high-rotation roller had a temperature at the raw material supplying side of 90° C., and a temperature at the kneaded product-discharging side of 85° C., and the low-rotation roller had a temperature at the raw material supplying side of 35° C., and a temperature at the kneaded product-discharging side of 35° C. In addition, the feeding rate of the raw material mixture to the kneader was 10 kg/h, and the average residence time in the kneader was about 3 minutes.

The kneaded product obtained above was roll-cooled with a cooling roller, and the cooled product was then roughly pulverized with a hammer-mill to a size of 1 mm or so. The roughly pulverized product obtained was finely pulverized and classified with an air jet type jet mill “IDS,” manufactured by Nippon Pneumatic Mfg. Co., Ltd., to provide toner particles having a volume-median particle size D₅₀ of 10 μm.

A 1-L polyethylene vessel was charged with 35 parts by mass of the toner particles obtained, 63.95 parts by mass of an insulating liquid as listed in Table C-3 (except for Example 5 being 62.9 parts by mass), and 1.05 parts by mass of a dispersant as listed in Table C-3 (except for Example 5 being 2.1 parts by mass) (3 parts by mass based on 100 parts by mass of the toner particles). The contents were stirred with “T.K. ROBOMIX,” manufactured by PRIMIX Corporation, under ice-cooling at a rotational speed of 7,000 r/min for 30 minutes, to provide a dispersion of toner particles, a solid content concentration of which was 36% by mass.

Next, the dispersion of toner particles obtained was subjected to wet-milling with 6 vessels-type sand mill “TSG-6,” manufactured by AIMEX CO., LTD., at a rotational speed of 1,300 r/min (peripheral speed 4.8 m/sec) using zirconia beads having a diameter of 0.8 mm at a volume filling ratio of 60% by volume to a volume-median particle size D₅₀ as listed in Table C-3. The beads were removed by filtration, and 44 parts by mass of the insulating liquid as listed in Table C-3 was added, based on 100 parts by mass of the filtrate, to dilute the filtrate, to provide a liquid developer, a solid content concentration of which was adjusted to 25% by mass, the liquid developer having physical properties as shown in Table C-3. In Comparative Examples 1 and 4, however, the dispersion of toner particles was solidified immediately after the beginning of wet-milling, so that a liquid developer could not be obtained.

### Test Example 1—Storage Stability

The storage stability was evaluated in the same manner as in Test Example 1 of the Example A series. The results are shown in Table C-3.

### Test Example 2—Low-Temperature Fusing Ability

The low-temperature fusing ability was evaluated in the same manner as in Test Example 2 of the Example A series. The results are shown in Table C-3.

TABLE C-3

| | | | | | | Liquid Developer | | | | | | |
|---|---|---|---|---|---|---|---|---|---|---|---|---|
| | | | | | | | | | D₅₀ of | D₅₀ of | | |
| | | | | | | | | | Toner | Toner | | Low- |
| | | Acid | TMA | | | Tg of | | | Particles | Particles | Storage | Temp. |
| | | Value of | Content, | | | Toner | Conduc- | Vis- | Before | After | Sta- | Fusing |
| | Resin | Resin, | % by | Insulating | | Particles, | tivity, | cosity, | Storage, | Storage, | bility, | Ability, |
| | Binder | mgKOH/g | mol¹⁾ | Liquid | Dispersant | ° C. | S/m | mPa · s | μm | μm | % | ° C. |
| Ex. 1 | Resin A | 59 | 25 | Hexyl | Dispersant A | 30 | 2.56 × 10⁻¹⁰ | 18 | 1.9 | 1.9 | 100 | 100 |
| | | | | laurate | | | | | | | | |
| Ex. 2 | Resin B | 69 | 32 | Hexyl | Dispersant A | 28 | 3.45 × 10⁻¹⁰ | 24 | 2.0 | 2.1 | 105 | 100 |
| | | | | laurate | | | | | | | | |
| Ex. 3 | Resin C | 37 | 21 | Hexyl | Dispersant A | 29 | 4.65 × 10⁻¹⁰ | 19 | 2.0 | 2.0 | 100 | 100 |
| | | | | laurate | | | | | | | | |
| Ex. 4 | Resin D | 35 | 6.7 | Hexyl | Dispersant A | 33 | 9.10 × 10⁻¹⁰ | 24 | 2.2 | 2.2 | 100 | 105 |
| | | | | laurate | | | | | | | | |
| Ex. 5 | Resin A | 59 | 25 | Hexyl | Dispersant B²⁾ | 32 | 4.87 × 10⁻¹⁰ | 22 | 2.0 | 2.0 | 100 | 105 |
| | | | | laurate | | | | | | | | |
| Ex. 6 | Resin A | 59 | 25 | Isopropyl | Dispersant A | 47 | 2.94 × 10⁻¹⁰ | 24 | 2.1 | 2.1 | 100 | 110 |
| | | | | palmitate | | | | | | | | |
| Comp. | Resin E | 9 | 0 | Methyl | Dispersant A | Unable to carry out wet-milling because of being solidified | | | | | | |
| Ex. 1 | | | | laurate | | | | | | | | |
| Comp. | Resin E | 9 | 0 | Methyl | Dispersant A | 10 | 1.12 × 10⁻⁸ | 45 | 6.2 | 10.6 | 171 | 130 |
| Ex. 2 | | | | oleate | | | | | | | | |
| Comp. | Resin E | 9 | 0 | Liquid | Dispersant A | 50 | 2.01 × 10⁻¹⁰ | 20 | 2.1 | 2.1 | 100 | 120 |
| Ex. 3 | | | | paraffin | | | | | | | | |
| Comp. | Resin E | 9 | 0 | Ethyl | Dispersant A | Unable to carry out wet-milling because of being solidified | | | | | | |
| Ex. 4 | | | | laurate | | | | | | | | |
| Comp. | Resin E | 9 | 0 | Butyl | Dispersant A | 34 | 4.43 × 10⁻⁸ | 26 | 2.1 | 2.2 | 105 | 130 |
| Ex. 5 | | | | oleate | | | | | | | | |

¹⁾Content in the carboxylic acid component
²⁾Dispersant B: “SOLSPARSE 11200,” manufactured by Lubrizol Corporation, a condensate of a polyethyleneimine and a carboxylic acid (condensed product of 12-hydroxystearic acid, average degree of polymerization: 7.0). Mw: 10,400, effective content: 50% by mass

It can be seen from the above results that the liquid developers of Examples 1 to 6 have smaller particle sizes, lowered viscosity, and high resistance, and excellent storage stability and low-temperature fusing ability.

On the other hand, in Comparative Examples 1 to 5, a polyester resin having a low acid value is used, and in Comparative Examples 1 and 4 where a methyl ester or an ethyl ester is used as a saturated fatty acid ester, the dispersion of toner particles is solidified due to dispersion failure of the toner particles in the course of the production, so that a liquid developer cannot be obtained. In addition, in Comparative Example 2 where an unsaturated fatty acid ester is used, the liquid developer has increased viscosity due to aggregation of the toner particles, thereby making it unsatisfactory in both storage stability and low-temperature fusing ability. In the liquid developer of Comparative Example 3 where a liquid paraffin is used and that of Comparative Example 5 where an unsaturated fatty acid ester which is an ester of an unsaturated fatty acid having 18 carbon atoms and an alcohol having 4 carbon atoms is used lack low-temperature fusing ability.

The liquid developer is suitably used in development or the like of latent images formed in, for example, electrophotography, electrostatic recording method, electrostatic printing method or the like.

1: A liquid developer comprising:
toner particles comprising a resin binder and a colorant;
a dispersant; and
an insulating liquid,
wherein the resin binder comprises a polyester-based resin which is a polyester resin or a composite resin having a polyester resin and a styrenic resin, wherein the polyester resin in the polyester-based resin is a polycondensate of an alcohol component comprising an aliphatic diol and a carboxylic acid component comprising a dicarboxylic or higher polycarboxylic acid compound, and
wherein the insulating liquid comprises 50% by mass or more of a saturated fatty acid ester which is an ester of a saturated fatty acid and an alcohol having 3 or more carbon atoms.

2: The liquid developer according to claim 1, wherein the saturated fatty acid has 8 or more and 16 or less carbon atoms.

3: The liquid developer according to claim 1, wherein the dispersant comprises a basic dispersant having a basic nitrogen-containing group.

4: The liquid developer according to claim 1, wherein the polyester-based resin has an acid value of 30 mgKOH/g or more and 90 mgKOH/g or less, and wherein the dispersant comprises a basic dispersant having a basic nitrogen-containing group.

5: The liquid developer according to claim 3, wherein the basic nitrogen-containing group is an imino group.

6: The liquid developer according to claim 1, wherein the dispersant comprises a silicone-based basic dispersant.

7: The liquid developer according to claim 6, wherein the silicone-based basic dispersant comprises at least one of:
a copolymer C in which monomers comprising a first monomer having a basic functional group and a second monomer having a polysiloxane chain are polymerized; and
a reaction product X of raw materials for a basic nitrogen-containing group having a nitrogen-containing group represented by the formula (VI) with raw materials for a dispersible group having a polysiloxane chain: 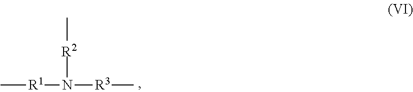
wherein each of R¹, R² and R³, which are identical or different, is an alkylene group having 1 or more carbon atoms and 22 or less carbon atoms.

8: The liquid developer according to claim 7, wherein a weight-average molecular weight of the second monomer in the copolymer C is 1,000 or more and 10,000 or less, a weight-average molecular weight of the copolymer C is 10,000 or more and 80,000 or less, and a mass ratio of the first monomer to the second monomer (first monomer/second monomer) is 3/97 or more and 70/30 or less.

9: The liquid developer according to claim 7, wherein a number-average molecular weight of the raw materials for a basic nitrogen-containing group in the reaction product X is 250 or more and 5,000 or less.

10-12. (canceled)

13: The liquid developer according to claim 1, wherein a viscosity at 25° C. of a liquid developer of which solid content concentration is 25% by mass is 3 mPa·s or more and 40 mPa·s or less.

14: The liquid developer according to claim 1, wherein the liquid developer has a conductivity of 5.0×10⁻⁸ S/m or less.

15: An electrophotographic developer, comprising:
the liquid developer of claim 1.
